(19) United States
(12) Patent Application Publication
(10) Pub. No.: US 2026/0186381 A1
(43) Pub. Date: Jul. 2, 2026

(54) CAMERA OPTICAL LENS

(71) Applicant: Changzhou AAC Raytech Optronics Co., Ltd., Changzhou City (CN)

(72) Inventor: Haichao Peng, Changzhou (CN)

(21) Appl. No.: 19/304,639

(22) Filed: Aug. 20, 2025

Related U.S. Application Data
(63) Continuation of application No. PCT/CN2024/144614, filed on Dec. 31, 2024.

(51) Int. Cl. G03B 17/17; G02B 9/60

(52) U.S. Cl. CPC G03B 17/17; G02B 9/60

(57) ABSTRACT

A camera optical lens is provided according to the present disclosure, which includes, from an object side to an image side in sequence: a first prism with a positive refractive power, a first lens with a negative refractive power, a second lens with a positive refractive power, a third lens, a fourth lens, and a fifth lens. A reflecting surface is provided between an object side surface and an image side surface of the first prism, the first lens, the second lens and the third lens form a first lens group, the fourth lens and the fifth lens form a second lens group, and the first lens group is arranged to be movable and adjustable along an optical axis of the camera optical lens, to switch the camera optical lens between a first state and a second state.

### TECHNICAL FIELD

The present disclosure relates to the technical field of optics, and in particular to a camera optical lens.

### BACKGROUND

With the rapid development and popularization of smart phones, the research, development and design of cameras have advanced rapidly. Moreover, as electronic products are developing towards having excellent functions and a slim and compact appearance, miniaturized cameras with good imaging quality have become the mainstream in the current market.

A telephoto camera can meet needs of consumers for shooting specific targets. Conventional telephoto camera has an excessively long total optical length, which fails to meet the requirements for slim and lightweight smart phone designs. However, a periscope telephoto camera design can significantly shorten the total optical length of the camera optical lens while satisfying the telephoto design. However, the optical performance of the existing periscope telephoto camera optical lens still cannot meet the demand.

### SUMMARY

An object of the present disclosure is to provide a camera optical lens that can meet the requirements of moving focusing, realize a large-aperture periscope design, and has excellent optical performance.

In order to solve the above technical problem, a first aspect of the present disclosure provides a camera optical lens comprising, from an object side to an image side in sequence: a first prism with a positive refractive power, a first lens with a negative refractive power, a second lens with a positive refractive power, a third lens, a fourth lens, and a fifth lens. A reflecting surface is provided between an object side surface and an image side surface of the first prism, the first lens, the second lens and the third lens form a first lens group, the fourth lens and the fifth lens form a second lens group, and the first lens group is arranged to be movable and adjustable along an optical axis of the camera optical lens, to switch the camera optical lens between a first state and a second state. The camera optical lens has a maximum focal length in the first state, and the camera optical lens has a minimum focal length in the second state. The camera optical lens further satisfies the following conditions: 4.00≤fA/IH≤5.50, −1.20≤Rp1/Rp2≤1.10, −2.00≤f1/fA≤−0.30, and 0.11≤BF/TTL≤0.33. fA represents a focal length of the camera optical lens in the first state, IH represents an image height of the camera optical lens, Rp1 represents a curvature radius of the object side surface of the first prism, Rp2 represents a curvature radius of the image side surface of the first prism; f1 represents a focal length of the first lens, BF represents a back focal length of the camera optical lens, and TTL represents a total optical length of the camera optical lens.

As an improvement, the camera optical lens further satisfies the following condition: 4.00≤fA/IH≤5.34.

As an improvement, the camera optical lens further satisfies the following condition: 2.30≤(R1+R2)/(R1−R2)≤4.60. R1 represents a curvature radius of an object side surface of the first lens, and R2 represents a curvature radius of an image side surface of the first lens.

As an improvement, the object side surface of the first prism is curved and convex in a paraxial region, and the camera optical lens further satisfies the following conditions: 1.41≤fp1/fA≤11.18, and 0.26≤dp1/TTL≤0.34. fp1 represents a focal length of the first prism, and dp1 represents a sum of an on-axis distance from the object side surface of the first prism to the reflecting surface and an on-axis distance from the reflecting surface to the image side surface of the first prism.

As an improvement, an object side surface of the first lens is convex in a paraxial region, an image side surface of the first lens is concave in the paraxial region, and the camera optical lens further satisfies the following condition: 0.018≤d1/TTL≤0.037. d1 represents an on-axial thickness of the first lens.

As an improvement, an object side surface of the second lens is convex in a paraxial region, and the camera optical lens further satisfies the following conditions: −1.25≤(R3+R4)/(R3−R4)≤0.24, 0.19≤f2/fA≤0.58, and 0.04≤d3/TTL≤0.08. R3 represents a curvature radius of the object side surface of the second lens, R4 represents a curvature radius of an image side surface of the second lens, f2 represents a focal length of the second lens, and d3 represents an on-axis thickness of the second lens.

As an improvement, the camera optical lens further satisfies the following conditions: −111.10≤(R5+R6)/(R5−R6)≤149.30, −11.10≤f3/fA≤129.47, and 0.015≤d5/TTL≤0.106. R5 represents a curvature radius of an object side surface of the third lens, R6 represents a curvature radius of an image side surface of the third lens, f3 represents a focal length of the third lens, and d5 represents an on-axis thickness of the third lens.

As an improvement, the camera optical lens further satisfies the following conditions: −3.93≤(R7+R8)/(R7−R8)≤6104.00, −205.84≤f4/fA≤45.03, and 0.06≤d7/TTL≤0.12. R7 represents a curvature radius of an object side surface of the fourth lens, R8 represents a curvature radius of an image side surface of the fourth lens, f4 represents a focal length of the fourth lens, and d7 represents an on-axis thickness of the fourth lens.

As an improvement, an image side surface of the fifth lens is concave in a paraxial region, and the camera optical lens further satisfies the following conditions: −5.93≤(R9+R10)/(R9−R10)≤6.18, −1.97≤f5/fA≤1.68, and 0.02≤d9/TTL≤0.11. R9 represents a curvature radius of an object side surface of the fifth lens, R10 represents a curvature radius of the image side surface of the fifth lens, f5 represents a focal length of the fifth lens, and d9 represents an on-axis thickness of the fifth lens.

As an improvement, the first prism is made of glass.

The beneficial effects of the present disclosure are as follows: the camera optical lens is formed by combining the prism and the lenses, where the five lenses are divided into two groups, and the front group moves for focusing, so that the focusing process is faster and smoother. In addition, the physical length of the lens can remain unchanged, which is beneficial to the allocation of internal space of the device. The camera optical lens meeting all conditions has a longer focal length under the condition of a fixed image height, which is beneficial to improving the magnification of the system. In addition, the camera optical lens is beneficial to alleviating the deflection degree of light entering the lens and facilitate the subsequent stable propagation. By reasonably distributing the optical focal length of the system, the system has better imaging quality and lower sensitivity. On the basis of achieving miniaturization, the long back focus is beneficial to the assembly of the module, and the total length of the optical system can be effectively controlled.

### BRIEF DESCRIPTION OF THE DRAWINGS

In order to make more clearly technical solutions of embodiments in the present disclosure, accompanying drawings, which are used in the description of the embodiments, will be described briefly in the following. Obviously, the accompanying drawings in the following description are only some examples of the present disclosure. Those skilled in the art, without creative work, may obtain other drawings based on these drawings.

FIG. 1a is a schematic structural diagram of a camera optical lens in a first state according to a first embodiment of the present disclosure.

FIG. 1b is a schematic structural diagram of a camera optical lens in a second state according to a first embodiment of the present disclosure.

FIG. 2a is a schematic structural diagram of a field curvature and a distortion of the camera optical lens shown in FIG. 1a.

FIG. 2b is a schematic structural diagram of a field curvature and a distortion of the camera optical lens shown in FIG. 1b.

FIG. 3a is a schematic diagram of a longitudinal aberration of the camera optical lens shown in FIG. 1a.

FIG. 3b is a schematic diagram of a longitudinal aberration of the camera optical lens shown in FIG. 1b.

FIG. 4a is a schematic diagram of a lateral color of the camera optical lens shown in FIG. 1a.

FIG. 4b is a schematic diagram of a lateral color of the camera optical lens shown in FIG. 1b.

FIG. 5a is a schematic structural diagram of a camera optical lens in a first state according to a second embodiment of the present disclosure.

FIG. 5b is a schematic structural diagram of a camera optical lens in a second state according to a second embodiment of the present disclosure.

FIG. 6a is a schematic structural diagram of a field curvature and a distortion of the camera optical lens shown in FIG. 5a.

FIG. 6b is a schematic structural diagram of a field curvature and a distortion of the camera optical lens shown in FIG. 5b.

FIG. 7a is a schematic diagram of a longitudinal aberration of the camera optical lens shown in FIG. 5a.

FIG. 7b is a schematic diagram of a longitudinal aberration of the camera optical lens shown in FIG. 5b.

FIG. 8a is a schematic diagram of a lateral color of the camera optical lens shown in FIG. 5a.

FIG. 8b is a schematic diagram of a lateral color of the camera optical lens shown in FIG. 5b.

FIG. 9a is a schematic structural diagram of a camera optical lens in a first state according to a third embodiment of the present disclosure.

FIG. 9b is a schematic structural diagram of a camera optical lens in a second state according to a third embodiment of the present disclosure.

FIG. 10a is a schematic structural diagram of a field curvature and a distortion of the camera optical lens shown in FIG. 9a.

FIG. 10b is a schematic structural diagram of a field curvature and a distortion of the camera optical lens shown in FIG. 9b.

FIG. 11a is a schematic diagram of a longitudinal aberration of the camera optical lens shown in FIG. 9a.

FIG. 11b is a schematic diagram of a longitudinal aberration of the camera optical lens shown in FIG. 9b.

FIG. 12a is a schematic diagram of a lateral color of the camera optical lens shown in FIG. 9a.

FIG. 12b is a schematic diagram of a lateral color of the camera optical lens shown in FIG. 9b.

FIG. 13a is a schematic structural diagram of a camera optical lens in a first state according to a fourth embodiment of the present disclosure.

FIG. 13b is a schematic structural diagram of a camera optical lens in a second state according to a fourth embodiment of the present disclosure.

FIG. 14a is a schematic structural diagram of a field curvature and a distortion of the camera optical lens shown in FIG. 13a.

FIG. 14b is a schematic structural diagram of a field curvature and a distortion of the camera optical lens shown in FIG. 13b.

FIG. 15a is a schematic diagram of a longitudinal aberration of the camera optical lens shown in FIG. 13a.

FIG. 15b is a schematic diagram of a longitudinal aberration of the camera optical lens shown in FIG. 13b.

FIG. 16a is a schematic diagram of a lateral color of the camera optical lens shown in FIG. 13a.

FIG. 16b is a schematic diagram of a lateral color of the camera optical lens shown in FIG. 13b.

FIG. 17a is a schematic structural diagram of a camera optical lens in a first state according to a fifth embodiment of the present disclosure.

FIG. 17b is a schematic structural diagram of a camera optical lens in a second state according to a fifth embodiment of the present disclosure.

FIG. 18a is a schematic structural diagram of a field curvature and a distortion of the camera optical lens shown in FIG. 17a.

FIG. 18b is a schematic structural diagram of a field curvature and a distortion of the camera optical lens shown in FIG. 17b.

FIG. 19a is a schematic diagram of a longitudinal aberration of the camera optical lens shown in FIG. 17a.

FIG. 19b is a schematic diagram of a longitudinal aberration of the camera optical lens shown in FIG. 17b.

FIG. 20a is a schematic diagram of a lateral color of the camera optical lens shown in FIG. 17a.

FIG. 20b is a schematic diagram of a lateral color of the camera optical lens shown in FIG. 17b.

FIG. 21a is a schematic structural diagram of a camera optical lens in a first state according to a sixth embodiment of the present disclosure.

FIG. 21b is a schematic structural diagram of a camera optical lens in a second state according to a sixth embodiment of the present disclosure.

FIG. 22a is a schematic structural diagram of a field curvature and a distortion of the camera optical lens shown in FIG. 21a.

FIG. 22b is a schematic structural diagram of a field curvature and a distortion of the camera optical lens shown in FIG. 21b.

FIG. 23a is a schematic diagram of a longitudinal aberration of the camera optical lens shown in FIG. 21a.

FIG. 23b is a schematic diagram of a longitudinal aberration of the camera optical lens shown in FIG. 21b.

FIG. 24a is a schematic diagram of a lateral color of the camera optical lens shown in FIG. 21a.

FIG. 24b is a schematic diagram of a lateral color of the camera optical lens shown in FIG. 21b.

FIG. 25a is a schematic structural diagram of a camera optical lens in a first state according to a seventh embodiment of the present disclosure.

FIG. 25b is a schematic structural diagram of a camera optical lens in a second state according to a seventh embodiment of the present disclosure.

FIG. 26a is a schematic structural diagram of a field curvature and a distortion of the camera optical lens shown in FIG. 25a.

FIG. 26b is a schematic structural diagram of a field curvature and a distortion of the camera optical lens shown in FIG. 25b.

FIG. 27a is a schematic diagram of a longitudinal aberration of the camera optical lens shown in FIG. 25a.

FIG. 27b is a schematic diagram of a longitudinal aberration of the camera optical lens shown in FIG. 25b.

FIG. 28a is a schematic diagram of a lateral color of the camera optical lens shown in FIG. 25a.

FIG. 28b is a schematic diagram of a lateral color of the camera optical lens shown in FIG. 25b.

### DETAILED DESCRIPTION OF THE EMBODIMENTS

In order to make the objects, technical solutions, and advantages of the present disclosure clearer, embodiments of the present disclosure are described in detail with reference to accompanying drawings in the following. Those skilled in the art can understand that, in the embodiments of the present disclosure, many technical details are provided to make readers better understand the present disclosure. However, even without these technical details and any changes and modifications based on the following embodiments, technical solutions claimed in the present disclosure can be implemented.

Referring to the accompanying drawings, a camera optical lens 10, 20, 30, 40, 50, 60, and 70 is provided according to the technical solutions of the present disclosure. The camera optical lens 10, 20, 30, 40, 50, 60 and 70 includes, from an object side to an image side in sequence: a first prism P1 with a positive refractive power, a first lens L1 with a negative refractive power, a second lens L2 with a positive refractive power, a third lens L3, a fourth lens L4, and a fifth lens L5. A reflecting surface RF is provided between an object side surface and an image side surface of the first prism P1, the first lens L1, the second lens L2 and the third lens L3 form a first lens group, the fourth lens L4 and the fifth lens L5 form a second lens group, and the first lens group is arranged to be movable and adjustable along an optical axis of the camera optical lens 10, 20, 30, 40, 50, 60, and 70, to switch the camera optical lens 10, 20, 30, 40, 50, 60, and 70 between a first state and a second state. The camera optical lens 10, 20, 30, 40, 50, 60, and 70 has a maximum focal length in the first state, and the camera optical lens 10, 20, 30, 40, 50, 60, and 70 has a minimum focal length in the second state.

fA represents the focal length of the camera optical lens 10, 20, 30, 40, 50, 60, and 70 in the first state, IH represents an image height of the camera optical lens 10, 20, 30, 40, 50, 60, and 70, Rp1 represents a curvature radius of the object side surface of the first prism P1, Rp2 represents a curvature radius of the image side surface of the first prism P1, f1 represents a focal length of the first lens L1, BF represents a back focal length of the camera optical lens 10, 20, 30, 40, 50, 60, and 70, and TTL represents a total optical length of the camera optical lens 10, 20, 30, 40, 50, 60, and 70. The camera optical lens 10, 20, 30, 40, 50, 60, and 70 satisfies the following conditions:

$$4. \leq fA / IH \leq 5.5 \qquad ( 1 )$$

$$- 1.2 \leq Rp 1 / Rp 2 \leq 1.10 \qquad ( 2 )$$

$$- 2. 0 \leq f 1 / fA \leq - 0.30 \qquad ( 3 )$$

$$0.11 \leq BF / TTL \leq 0.33 \qquad ( 4 )$$

The camera optical lens 10, 20, 30, 40, 50, 60, and 70 is a periscope optical lenses with five-piece lenses. The camera optical lens 10, 20, 30, 40, 50, 60, and 70 includes, from the object side to the image side, the first prism P1, the first lens L1, the second lens L2, the third lens L3, the fourth lens L4, and the fifth lens L5.

The five-piece lenses of the camera optical lens 10, 20, 30, 40, 50, 60, and 70 are respectively the first lens L1, the second lens L2, the third lens L3, the fourth lens L4, and the fifth lens L5. The five-piece lenses are divided into two groups (the first three lenses form a front group, and the last two lenses form a rear group), namely the first lens group and the second lens group. The first lens group is closer to the object side than the second lens group.

The first lens group is the front group, which includes the first lens L1, the second lens L2 and the third lens L3. An object side surface of the first lens group is an object side surface of the first lens L1, and an image side surface of the first lens group is an image side surface of the third lens L3. The second lens group is the rear group, which includes the fourth lens L4 and the fifth lens L5. An object side surface of the second lens group is an object side surface of the fourth lens L4, and an image side surface of the second lens group is an image side surface of the fifth lens L5. The front group including the first lens L1, the second lens L2 and the third lens L3 is movable for focusing. The focusing process is faster and smoother, and the physical length of the camera optical lens 10, 20, 30, 40, 50, 60, 70 can remain unchanged, which is beneficial to the allocation of the space of internal space of the device.

The first lens group is located between the first prism P1 and the second lens group, and is movable along the optical axis of the camera optical lens 10, 20, 30, 40, 50, 60, and 70, so that an on-axis distance from the image side surface of the first prism P1 to the object side surface of the first lens group, and an on-axis distance from the image side surface of the first lens group to the object side surface of the second lens group are adjustable. In this way, the first lens group serves as a moving zoom group, and the second lens group serves as a fixed-focus group. By moving the first lens group, the focal length of the camera optical lens 10, 20, 30, 40, 50, 60, and 70 can be changed, so as to ensure that the camera optical lens 10, 20, 30, 40, 50, 60, and 70 achieves good imaging effects in both the first state and the second state. The first state refers to a state where the camera optical lens 10, 20, 30, 40, 50, 60, and 70 has a maximum focal length, and the second state refers to a state where the camera optical lens 10, 20, 30, 40, 50, 60, and 70 has a minimum focal length. For example, the first state can be a telephoto state or a state with an infinite object distance. The second state can be a short-focus state, a macro state, or a state with an object distance of 200 mm. In this way, the camera optical lens 10, 20, 30, 40, 50, 60, and 70 can achieve internal focusing of the camera optical lens 10, 20, 30, 40, 50, 60, and 70 by means of the movement of the front group for focusing.

The condition (1) specifies a ratio of the focal length fA of the camera optical lens 10, 20, 30, 40, 50, 60, and 70 in the first state to the image height IH. Within the range defined by the condition (1), the camera optical lens 10, 20, 30, 40, 50, 60, and 70 has a longer focal length when the image height IH is fixed, which is beneficial to increasing the magnification of the camera optical lens 10, 20, 30, 40, 50, 60, and 70. More preferably, the camera optical lens 10, 20, 30, 40, 50, 60, and 70 further satisfies the following condition: 4.00≤fA/IH≤5.34.

The condition (2) specifies a range of a ratio of the curvature radius Rp1 of the object side surface of the first prism P1 to the curvature radius Rp2 of the image side surface of the first prism P1, so as to control the shapes of the object side surface and the image side surface of the first prism P1. Within the range defined by the condition (2), it is beneficial to alleviating the deflection degree of light entering the lens and the subsequent stable propagation.

The condition (3) specifies a range of a ratio of the focal length of the first lens L1 to the focal length fA of the camera optical lens 10, 20, 30, 40, 50, 60, and 70 in the first state. By reasonably distributing the optical focal length of the camera optical lenses 10, 20, 30, 40, 50, 60, and 70 within the range defined by the condition (3), the camera optical lens 10, 20, 30, 40, 50, 60, and 70 can have better imaging quality and lower sensitivity.

The condition (4) specifies a range of a ratio of the back focal length of the camera optical lens 10, 20, 30, 40, 50, 60, and 70 to the total optical length of the camera optical lens 10, 20, 30, 40, 50, 60, and 70. By controlling the back focal length of the camera optical lens 10, 20, 30, 40, 50, 60, and 70 within the range defined by the condition (4), a long back focal length is beneficial to the assembly of the module on the basis of achieving miniaturization. In addition, the total optical length of the camera optical lens 10, 20, 30, 40, 50, 60, and 70 can be effectively controlled.

Under the condition that the above conditions are satisfied, by dividing the five-piece lens into the first lens group and the second lens group, and with the first lens group moving for focusing, the internal focusing method of the camera optical lens 10, 20, 30, 40, 50, 60, and 70 is realized. The ratio of the focal length of the camera optical lens 10, 20, 30, 40, 50, 60, and 70 to the image height is set, so that the camera optical lens 10, 20, 30, 40, 50, 60, and 70 has a longer focal length when the image height is fixed, which is beneficial to improving the magnification of the camera optical lens 10, 20, 30, 40, 50, 60, and 70. Setting the concave-convex shape of the first prism P1 is beneficial to alleviating the deflection degree of light passing through the first prism P1. By reasonably distributing the optical focal length of the camera optical lens 10, 20, 30, 40, 50, 60, and 70, the camera optical lens 10, 20, 30, 40, 50, 60, and 70 can have good imaging quality and low sensitivity. By controlling the back focal length of the camera optical lens 10, 20, 30, 40, 50, 60, and 70, the total optical length of the camera optical lens 10, 20, 30, 40, 50, 60, and 70 can be effectively controlled.

Based on the above conditions and the achievable functions, the characteristics of each lens are further detailed as follows.

Preferably, R1 represents a curvature radius of an object side surface of the first lens L1, and R2 represents a curvature radius of an image side surface of the first lens L1, and the camera optical lens 10, 20, 30, 40, 50, 60, and 70 further satisfies the following condition:

$$2.3 \leq ( R 1 + R 2 ) / ( R 1 - R 2 ) \leq 4.60 \qquad ( 5 )$$

The condition (5) specifies a range of a ratio of the curvature radius R1 of the object side surface to the curvature radius R2 of the image side surface of the first lens L1. Under the condition (5), by reasonably controlling the surface shape of the first lens L1, it is beneficial to reducing the sensitivity of the camera optical lens 10, 20, 30, 40, 50, 60, and 70. The manufacturing yield is improved by reducing the molding difficulty, the stray light generated by the lens can be reduced and the imaging quality of the lens can be improved.

The object side surface of the first prism P1 is curved and convex in a paraxial region, and the image side surface of the first prism P1 is convex or concave in the paraxial region. The object side surface of the first prism P1 can be set to other surface shape.

Preferably, fp1 represents a focal length of the first prism P1, and dp1 represents a sum of an on-axis distance from the object side surface of the first prism P1 to the reflecting surface and an on-axis distance from the reflecting surface to the image side surface of the first prism P1. The camera optical lens 10, 20, 30, 40, 50, 60, and 70 further satisfies the following conditions:

$$1.41 \leq fp 1 / fA \leq 11 \text{.18} \qquad ( 6 )$$

$$0.26 \leq dp 1 / TTL \leq 0.34 \qquad ( 7 )$$

The condition (6) specifies a range of a ratio of the focal length fp1 of the first prism P1 to the focal length fA of the camera optical lens 10, 20, 30, 40, 50, 60, and 70 in the first state. Within the range, it is beneficial to improving the optical performance of the camera optical lens 10, 20, 30, 40, 50, 60, and 70.

The condition (7) specifies a range of a ratio of the sum dp1 of the on-axis distance from the object side surface of the first prism P1 to the reflecting surface and the on-axis distance from the reflecting surface to the image side surface of the first prism P1 to the total optical length TTL of the camera optical lens 10, 20, 30, 40, 50, 60, and 70. Within the range, it is beneficial to realizing the miniaturized design of the camera optical lens 10, 20, 30, 40, 50, 60, and 70.

An object side surface of the first lens L1 is convex in a paraxial region, an image side surface of the first lens L1 is concave in the paraxial region, and the object side surface and the image side surface of the first lens L1 can be set to other concave-convex distribution conditions.

d1 represents an on-axial thickness of the first lens L1, TTL represents the total optical length of the camera optical lens 10, 20, 30, 40, 50, 60, and 70, and the camera optical lens 10, 20, 30, 40, 50, 60, and 70 further satisfies the following condition:

$$0.18 \leq d 1 / TTL \leq 0.037 \qquad ( 8 )$$

The condition (8) specifies a range of a ratio of the on-axis thickness d1 of the first lens L1 to the total optical length TTL of the camera optical lens 10, 20, 30, 40, 50, 60, and 70. Within the range defined by the condition, it is beneficial to realizing a miniaturized design.

An object side surface of the second lens L2 is convex in a paraxial region, and an image side surface of the second lens L2 is concave or convex in the paraxial region. The object side surface of the second lens L2 may be set to be concave.

Preferably, R3 represents a curvature radius of the object side surface of the second lens L2, and R4 represents a curvature radius of the image side surface of the second lens L2, f2 represents a focal length of the second lens L2, and d3 represents an on-axis thickness of the second lens L2. The camera optical lens 10, 20, 30, 40, 50, 60, and 70 further satisfies the following conditions:

$$- 1.25 \leq ( R 3 + R 4 ) / ( R 3 - R 4 ) \leq 0.24 \qquad ( 9 )$$

$$0.19 \leq f 2 / fA \leq 0.58 \qquad ( 10 )$$

$$0.04 \leq d 3 / TTL \leq 0.08 \qquad ( 11 )$$

The condition (9) specifies a shape of the second lens L2, which is beneficial to the molding of the second lens L2. Within the range defined by the condition (10), it can alleviate the deflection degree of light passing through the lens and effectively reduce the aberration.

The condition (10) specifies a range of a ratio of the focal length f2 of the second lens L2 to the focal length fA of the camera optical lens 10, 20, 30, 40, 50, 60, and 70 in the first state. Within the range, the system can have good imaging quality and low sensitivity with the reasonable distribution of optical power.

The condition (11) specifies a range of a ratio of the on-axis thickness d3 of the second lens L2 to the total optical length TTL of the camera optical lens 10, 20, 30, 40, 50, 60, and 70. Within the range defined by the above condition, it is beneficial to realizing the miniaturized design of the camera optical lens 10, 20, 30, 40, 50, 60, and 70.

The third lens L3 has a positive refractive power or a negative refractive power, an object side surface of the third lens L3 is concave or convex in a paraxial region, and an image side surface of the third lens L3 is concave or convex in the paraxial region.

Preferably, R5 represents a curvature radius of the object side surface of the third lens L3, R6 represents a curvature radius of the image side surface of the third lens L3, f3 represents a focal length of the third lens L3, and d5 represents an on-axis thickness of the third lens L3. The camera optical lens 10, 20, 30, 40, 50, 60, and 70 further satisfies the following conditions:

$$- 111.10 \leq ( R 5 + R 6 ) / ( R 5 - R 6 ) \leq 149 \text{.30} \qquad ( 12 )$$

$$- 11.1 \leq f 3 / fA \leq 129.47 \qquad ( 13 )$$

$$0.015 \leq d 5 / TTL \leq 0.106 \qquad ( 14 )$$

The condition (12) specifies a shape of the third lens L3. Within the defined range, with the miniaturization of the camera optical lens 10, 20, 30, 40, 50, 60, and 70, it is beneficial to correcting the problem of axial chromatic aberration.

The condition (13) defines a range of a ratio of the focal length f3 of the third lens L3 to the focal length fA of the camera optical lens 10, 20, 30, 40, 50, 60, and 70 in the first state, which is beneficial to improving the performance of the optical system.

The condition (14) specifies a range of a ratio of the on-axis thickness d5 of the third lens L3 to the total optical length TTL of the camera optical lens 10, 20, 30, 40, 50, 60, and 70. Within the parameter range, it is beneficial to realizing the miniaturized design of the camera optical lens 10, 20, 30, 40, 50, 60, and 70.

The fourth lens L4 has a positive refractive power or a negative refractive power, an object side surface of the fourth lens L4 is concave or convex in a paraxial region, and an image side surface of the fourth lens L4 is concave or convex in the paraxial region.

Preferably, R7 represents a curvature radius of the object side surface of the fourth lens L4, R8 represents a curvature radius of the image side surface of the fourth lens L4, and f4 represents a focal length of the fourth lens L4, and d7 represents an on-axis thickness of the fourth lens L4. The camera optical lens 10, 20, 30, 40, 50, 60, and 70 further satisfies the following conditions:

$$- 3.93 \leq ( R 7 + R 8 ) / ( R 7 - R 8 ) \leq 610 \; 4 \text{.00} \qquad ( 15 )$$

$$- 205. 84 \leq f 4 / fA \leq 45.03 \qquad ( 16 )$$

$$0.06 \leq d 7 / TTL \leq 0.12 \qquad ( 17 )$$

The condition (15) specifies a shape of the fourth lens L3. Within the range specified by the condition (15), the shape of the fourth lens L4 is reasonably controlled, so that the fourth lens LA can effectively correct the system spherical aberration.

The condition (16) specifies a range of a ratio of the focal length f4 of the fourth lens L4 to the focal length fA of the camera optical lens 10, 20, 30, 40, 50, 60, and 70 in the first state. Within the range of the condition (16), the light angles of the camera optical lens 10, 20, 30, 40, 50, and 60 are gentle, which reduces the tolerance sensitivity.

The condition (17) specifies a range of a ratio of the on-axis thickness d7 of the fourth lens L4 to the total optical length TTL of the camera optical lens 10, 20, 30, 40, 50, 60, and 70. Within the range, it is beneficial to realizing the miniaturized design of the camera optical lens 10, 20, 30, 40, 50, 60, and 70.

The fifth lens L5 has a positive refractive power or a negative refractive power, an object side surface of the fifth lens L5 is concave or convex in a paraxial region, and an image side surface of the fifth lens L5 is concave in the paraxial region. The image side surface of the fifth lens L5 may be set to be convex.

Preferably, R9 represents a curvature radius of the object side surface of the fifth lens L5, R10 represents a curvature radius of the image side surface of the fifth lens L5, f5 represents a focal length of the fifth lens L5, and d9 represents an on-axis thickness of the fifth lens L5. The camera optical lens 10, 20, 30, 40, 50, 60, and 70 further satisfies the following conditions:

$$- 5.93 \leq ( R 9 + R 10 ) / ( R 9 - R 10 ) \leq 6 \text{.18} \qquad ( 18 )$$

$$- 1.97 \leq f 5 / fA \leq 1.68 \qquad ( 19 )$$

$$0.02 \leq d 9 / TTL \leq 0.1 1 \qquad ( 20 )$$

The condition (18) specifies a shape of the fifth lens L5. Within the range, with the miniaturization of the camera optical lens 10, 20, 30, 40, 50, 60, and 70, it is beneficial to correcting the problem of axial chromatic aberration.

The condition (19) specifies a range of a ratio of the focal length f5 of the fifth lens L5 to the focal length fA of the camera optical lens 10, 20, 30, 40, 50, 60, and 70 in the first state. Within the range, it is beneficial to reducing aberration of the system and the miniaturization of the lens.

The condition (20) specifies a ratio of the on-axis thickness d9 of the fifth lens L5 to the total optical length TTL of the camera optical lens 10, 20, 30, 40, 50, 60, and 70, which is beneficial to realizing the miniaturized design of the camera optical lens 10, 20, 30, 40, 50, 60, and 70.

In the present disclosure, the first prism P1 is made of glass, and the first lens L1, the second lens L2, the third lens L3, the fourth lens L4, and the fifth lens L5 are all made of plastic. In other feasible cases, the first prism P1 and the lenses can also be made of other materials.

In the present disclosure, optical elements such as an optical filter GF are arranged between the fifth lens L5 and the imaging surface Si. The optical filter GF can be a glass cover plate or an optical filter. In other examples, the optical filter GF can also be arranged at other positions.

In the present disclosure, an aperture stop ST may be arranged between the first prism P1 and the first lens L1.

The camera optical lens 10, 20, 30, 40, 50, 60, and 70 according to the present disclosure can realize a large-aperture periscope design and has excellent optical performance.

Hereinafter, the camera optical lens 10, 20, 30, 40, 50, 60 and 70 according to the present disclosure will be described with examples. The symbols recorded in each example are as follows. The units of focal length, on-axis distance, central curvature radius and on-axis thickness are mm.

TTL: a total optical length (an on-axial distance from the object side surface of the first prism P1 to the imaging surface Si), in mm.

BF: a back focal length (an on-axis distance from the image side surface of the fifth lens L5 to the imaging surface Si), in mm.

The technical solutions of the present disclosure will be specifically described in the following seven embodiments.

### First Embodiment

The first prism P1 has a positive refractive power, with the object side surface being convex in the paraxial region and the image side surface being concave in the paraxial region.

The first lens L1 has a negative refractive power, with the object side surface being convex in the paraxial region and the image side surface being concave in the paraxial region.

The second lens L2 has a positive refractive power, with the object side surface being convex in the paraxial region and the image side surface being convex in the paraxial region.

The third lens L3 has a negative refractive power, with the object side surface being convex in the paraxial region and the image side surface being concave in the paraxial region.

The fourth lens L4 has a positive refractive power, with the object side surface being concave in the paraxial region and the image side surface being convex in the paraxial region.

The fifth lens L5 has a negative refractive power, with the object side surface being convex in the paraxial region and the image side surface being concave in the paraxial region.

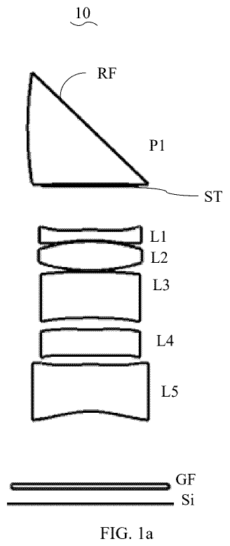

FIG. 1a and FIG. 1b are schematic structural diagrams of the camera optical lens 10 in the first embodiment. The design data of the camera optical lens 10 in the first embodiment of the present disclosure are shown below.

Table 1 lists the curvature radius R of the object side surfaces and the image side surfaces from the first prism P1 to the fifth lens L5 forming the camera optical lens 10, the on-axis thicknesses of the lenses, the on-axis distances d between lenses, the refractive indexes nd, and the Abbe number vd of the first prism P1 to the fifth lens L5 that constitute the camera optical lens 10 in the first embodiment of the present disclosure. It should be noted that in this embodiment, the units of distance, radius, and thickness are all millimeters (mm).

TABLE 1

| | R | d | | nd | | vd | |
|---|---|---|---|---|---|---|---|
| ST | ∞ | d0 | −5.737 | / | / | / | / |
| Rp1 | 17.567 | dp1 | 5.637 | nd1 | 1.6188 | vd1 | 63.19 |
| Rp2 | 87.833 | dp2 | dp2 | | | | |
| R1 | 13.655 | d1 | 0.500 | nd2 | 1.6153 | vd2 | 25.94 |
| R2 | 6.957 | d2 | 0.063 | | | | |
| R3 | 11.610 | d3 | 1.406 | nd3 | 1.5444 | vd3 | 55.82 |
| R4 | −7.209 | d4 | 0.050 | | | | |
| R5 | 28.959 | d5 | 2.241 | nd4 | 1.6449 | vd4 | 22.54 |
| R6 | 22.003 | d6 | d6 | | | | |
| R7 | −30.996 | d7 | 1.275 | nd5 | 1.6610 | vd5 | 20.53 |
| R8 | −24.477 | d8 | 0.432 | | | | |
| R9 | 15.677 | d9 | 2.266 | nd6 | 1.5346 | vd6 | 55.69 |
| R10 | 4.305 | d10 | 3.539 | | | | |
| R11 | ∞ | d11 | 0.210 | ndg | 1.5168 | vdg | 64.17 |
| R12 | ∞ | d12 | 0.751 | | | | |

Where dp1 = “dp1-01” + “dp1-02”, “dp1-01” = 2.925, “dp1-02” = 2.712.

Table 2 lists the data of relevant optical parameters of the camera optical lens 10 in the first state and the second state respectively according to the first embodiment of the present disclosure.

TABLE 2

| | In the first state | In the second state |
|---|---|---|
| fA | 14.515 | 12.760 |
| FOV | 27.23° | 25.13° |
| FNO | 2.80 | 3.17 |
| dp2 | 2.225 | 0.345 |
| d6 | 0.569 | 2.449 |

The meanings of each symbol in the above table are listed as follows:
R: a curvature radius of an optical surface, or a central curvature radius of the lens;
ST: aperture stop;
Rp1: the curvature radius of the object side surface of the first prism P1;
Rp2: the curvature radius of the image side surface of the first prism P1;
R1: the curvature radius of the object side surface of the first lens L1;
R2: the curvature radius of the image side surface of the first lens L1;
R3: the curvature radius of the object side surface of the second lens L2;
R4: the curvature radius of the image side surface of the second lens L2;
R5: the curvature radius of the object side surface of the third lens L3;
R6: the curvature radius of the image side surface of the third lens L3;
R7: the curvature radius of the object side surface of the fourth lens L4;
R8: the curvature radius of the image side surface of the fourth lens L4;
R9: the curvature radius of the object side surface of the fifth lens L5;
R10: the curvature radius of the image side surface of the fifth lens L5;
R11: the curvature radius of the object side surface of the optical filter GF;
R12: the curvature radius of the image side surface of the optical filter GF;
d: an on-axis thickness of the lens and an on-axis distance between adjacent lenses;
d0: the on-axis distance from the aperture stop ST to the object side surface of the first prism P1;
dp1: the sum of the on-axis distance from the object side surface of the first prism P1 to the reflecting surface and the on-axis distance from the reflecting surface to the image side surface of the first prism P1;
dp1-01: the on-axis distance from the object side surface of the first prism P1 to the reflecting surface;
dp1-02: the on-axis distance from the reflecting surface of the first prism P1 to the image side surface;
dp2: the on-axis distance from the image side surface of the first prism P1 to the object side surface of the first lens L1;
d1: the on-axis thickness of the first lens L1;
d2: the on-axis distance from the image side surface of the first lens L1 to the object side surface of the second lens L2;
d3: the on-axis thickness of the second lens L2;
d4: the on-axis distance from the image side surface of the second lens L2 to the object side surface of the third lens L3;
d5: the on-axis thickness of the third lens L3;
d6: the on-axis distance from the image side surface of the third lens L3 to the object side surface of the fourth lens L4;
d7: the on-axis thickness of the fourth lens L4;
d8: the on-axis distance from the image side surface of the fourth lens L4 to the object side surface of the fifth lens L5;
d9: the on-axis thickness of the fifth lens L5;
d10: the on-axis distance from the image side surface of the fifth lens L5 to the object side surface of the optical filter GF;
d11: the on-axis thickness of the optical filter GF;
d12: the on-axis distance from the image side surface of the optical filter GF to the imaging surface Si;
nd: a refractive index of the d-line
nd1: the refractive index of the first prism P1;
nd2: the refractive index of the first lens L1;
nd3: the refractive index of the second lens L2;
nd4: the refractive index of the third lens L3;
nd5: the refractive index of the fourth lens L4;
nd6: the refractive index of the fifth lens L5;
ndg: the refractive index of the optical filter GF;
vd: Abbe number;
vd1: Abbe number of the first prism P1;
vd2: Abbe number of the first lens L1;
vd3: Abbe number of the second lens L2;
vd4: Abbe number of the third lens L3;
vd5: Abbe number of the fourth lens LA;
vd6: Abbe number of the fifth lens L5;
vdg: Abbe number of the optical filter GF;

Table 3 shows the conic coefficient k and aspheric surface coefficient of the camera optical lens 10.

TABLE 3

| | Conic | | | | | |
|---|---|---|---|---|---|---|
| | coefficient | Aspheric surface coefficient | | | | |
| | k | A4 | A6 | A8 | A10 | A12 |
| R1 | 3.30906E+00 | −1.57620E−04 | 2.49840E−06 | −1.48650E−06 | 4.58920E−07 | −1.11090E−07 |
| R2 | 0.00000E+00 | 0.00000E+00 | 0.00000E+00 | 0.00000E+00 | 0.00000E+00 | 0.00000E+00 |
| R3 | −1.09981E+02 | −4.57880E−03 | −9.32030E−03 | 5.81180E−03 | −2.21940E−03 | 5.76610E−04 |
| R4 | 2.48705E+00 | 2.48420E−02 | −4.72470E−02 | 3.15370E−02 | −1.24670E−02 | 2.97410E−03 |
| R5 | 1.91300E+01 | 3.86030E−02 | −4.39600E−02 | 2.96630E−02 | −1.21420E−02 | 3.02450E−03 |
| R6 | 6.44464E+00 | −4.37110E−03 | 1.65480E−02 | −1.29760E−02 | 6.01520E−03 | −1.79760E−03 |
| R7 | 6.05516E+01 | −4.54330E−03 | 1.48590E−02 | −1.28340E−02 | 6.34300E−03 | −2.04720E−03 |
| R8 | 1.09912E+01 | 2.27580E−03 | 5.79140E−04 | −2.96690E−04 | 8.40320E−05 | −1.52690E−05 |
| R9 | 1.57060E+02 | 8.33090E−03 | −4.60390E−04 | 1.44300E−04 | −2.75780E−05 | 1.42030E−06 |
| R10 | −1.83726E+02 | 5.10900E−03 | −3.91500E−04 | −1.75750E−05 | 2.96880E−04 | −2.26990E−04 |
| R11 | 4.15627E+01 | −1.11150E−02 | −1.78020E−04 | −5.13810E−04 | 6.97730E−04 | −4.28030E−04 |
| R12 | −6.94072E+00 | −2.01040E−03 | −1.06210E−03 | 4.90860E−04 | −1.65910E−04 | 4.08310E−05 |

| | Conic coefficient | | | | | |
|---|---|---|---|---|---|---|
| | k | A14 | A16 | A18 | A20 | / |
| R1 | 3.30906E+00 | 1.75480E−08 | −1.54790E−09 | 5.71160E−11 | 0.00000E+00 | / |
| R2 | 0.00000E+00 | 0.00000E+00 | 0.00000E+00 | 0.00000E+00 | 0.00000E+00 | / |
| R3 | −1.09981E+02 | −1.04300E−04 | 1.32380E−05 | −1.10140E−06 | 4.46840E−08 | / |
| R4 | 2.48705E+00 | −4.15200E−04 | 3.08360E−05 | −9.05700E−07 | −3.01930E−09 | / |
| R5 | 1.91300E+01 | −4.57030E−04 | 4.03070E−05 | −1.86910E−06 | 3.36280E−08 | / |
| R6 | 6.44464E+00 | 3.43420E−04 | −3.96800E−05 | 2.47570E−06 | −6.20150E−08 | / |
| R7 | 6.05516E+01 | 4.33160E−04 | −5.73700E−05 | 4.28990E−06 | −1.37770E−07 | / |
| R8 | 1.09912E+01 | 2.46280E−06 | −3.16030E−07 | 1.94350E−08 | 0.00000E+00 | / |
| R9 | 1.57060E+02 | 1.33220E−06 | −3.06240E−07 | 2.19460E−08 | 0.00000E+00 | / |
| R10 | −1.83726E+02 | 8.87680E−05 | −1.95760E−05 | 2.33760E−06 | −1.16950E−07 | / |
| R11 | 4.15627E+01 | 1.49530E−04 | −3.06940E−05 | 3.46530E−06 | −1.66290E−07 | / |
| R12 | −6.94072E+00 | −6.85460E−06 | 7.32370E−07 | −4.44500E−08 | 1.15570E−09 | / |

It should be noted that the aspheric surface of each lens in this embodiment uses the aspheric surface represented by the following formula (21), but the specific form of the following formula (21) is only an example, and in fact, it is not limited to the aspheric polynomial form represented by the formula (21).

$$z = ( {cr}^{2} ) / {\{ 1 + [ 1 - ( k + 1 ) ( {c}^{2} {r}^{2} ) ] \}}^{1 / 2} \} + A 4 {r}^{4} + A 6 {r}^{6} + A 8 {r}^{8} + A 10 {r}^{10} + A 12 {r}^{12} + A 14 {r}^{14} + A 16 {r}^{16} + A 18 {r}^{18} + A 20 {r}^{20} \qquad ( 21 )$$

Among them, K is a conic coefficient, A4, A6, A8, A10, A12, A14, A16, A18 and A20 are aspheric surface coefficients. c is a curvature at the center of the optical surface, r is a perpendicular distance from a point on an aspheric curve to the optical axis, z is an aspheric depth (a perpendicular distance between a point on the aspheric surface at a distance r from the optical axis and a tangent plane tangent to a vertex on the optical axi of the aspheric surface).

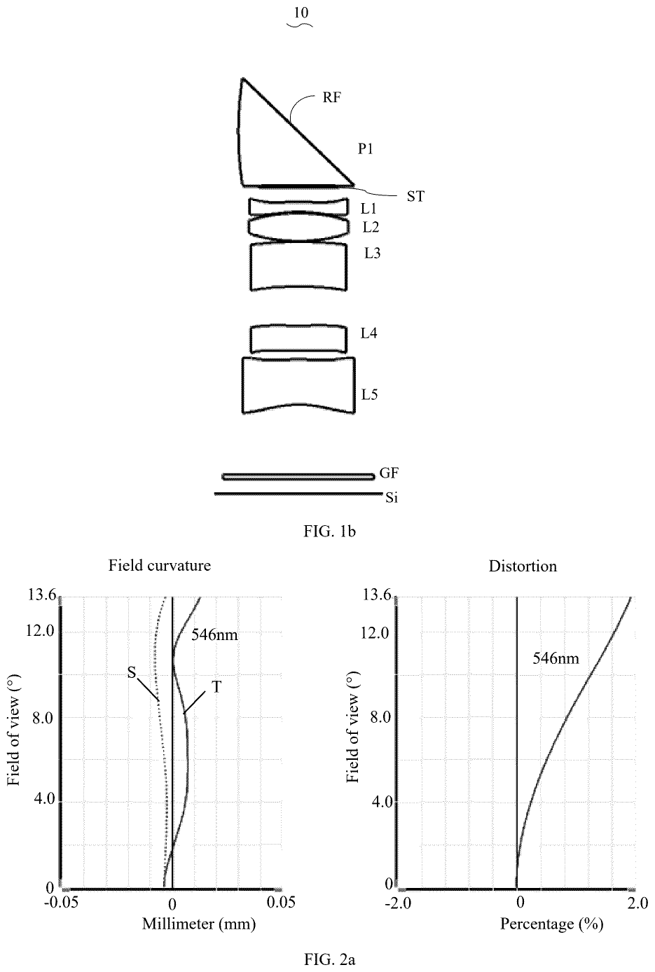

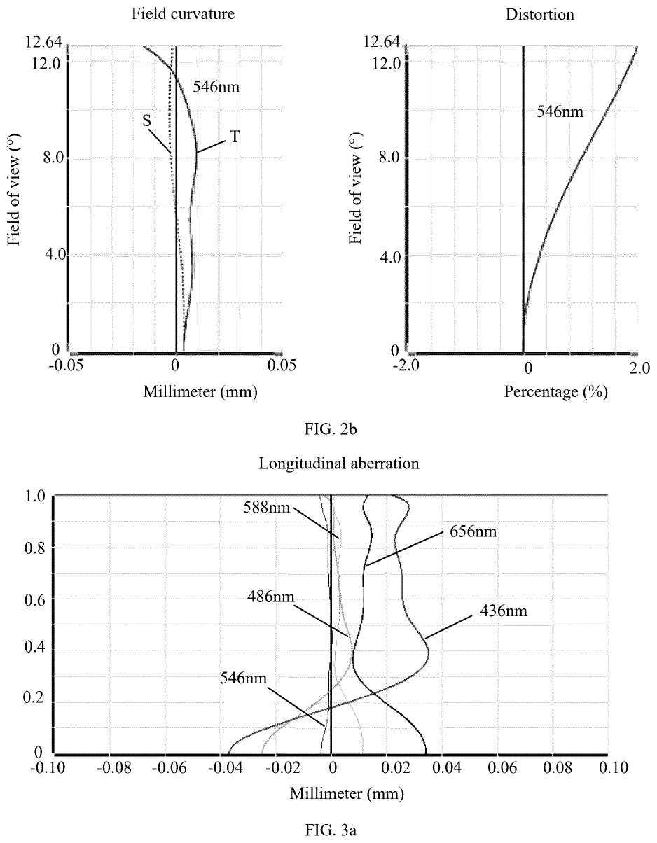

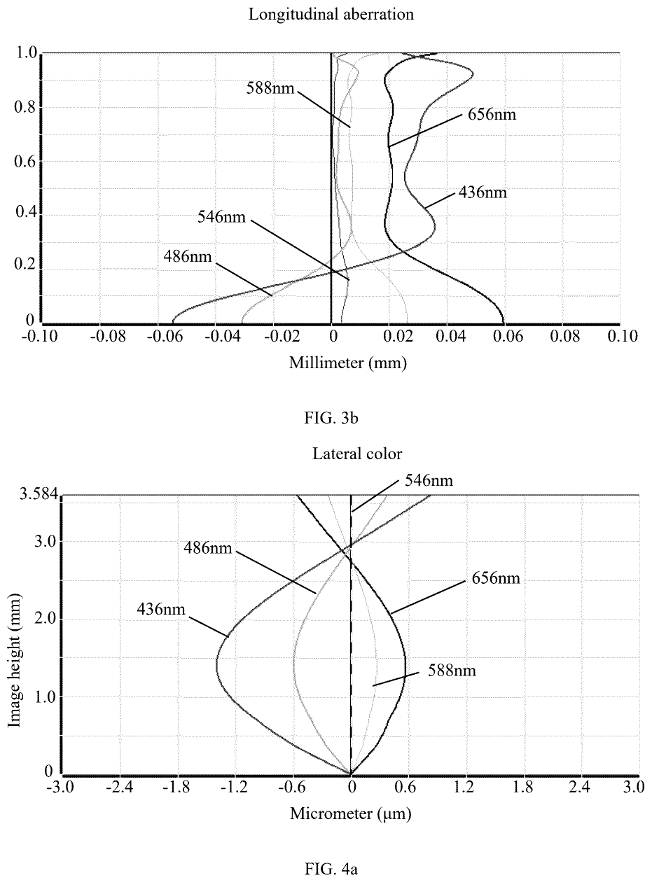

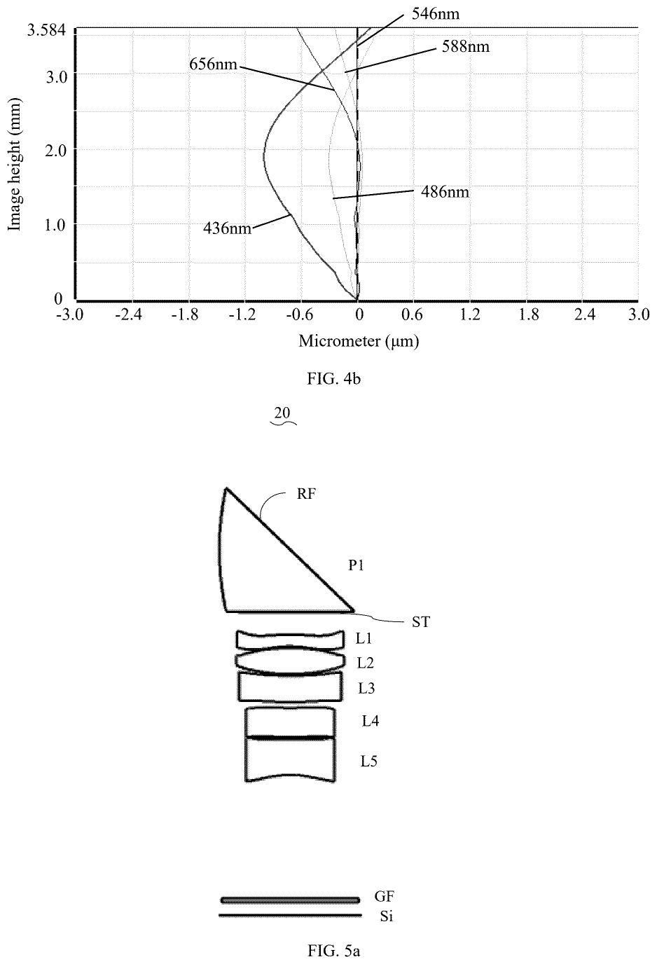

FIG. 2a and FIG. 2b are the schematic diagrams of a field curvature and a distortion after light with a wavelength of 546 nm passes through the camera optical lens 10 of the first embodiment. FIG. 3a and FIG. 3b are the schematic diagrams of a longitudinal aberration after light with wavelengths of 436 nm, 486 nm, 546 nm, 588 nm, and 656 nm pass through the camera optical lens 10 of the first embodiment. FIG. 4a and FIG. 4b are the schematic diagrams of a lateral color after light with wavelengths of 436 nm, 486 nm, 546 nm, 588 nm, and 656 nm pass through the camera optical lens 10 of the first embodiment.

In this embodiment, an entrance pupil diameter ENPD of the camera optical lens 10 in the first state is 5.184 mm, an image height IH is 3.584 mm, and a field of view FOV is 27.23°. The camera optical lens 10 can realize a large-aperture periscope design and has excellent optical performance, and the on-axis and off-axis chromatic aberrations are fully corrected with excellent optical characteristics.

### Second Embodiment

The first prism P1 has a positive refractive power, with the object side surface being convex in the paraxial region and the image side surface being flat in the paraxial region.

The first lens L1 has a negative refractive power, with the object side surface being convex in the paraxial region and the image side surface being concave in the paraxial region.

The second lens L2 has a positive refractive power, with the object side surface being convex in the paraxial region and the image side surface being convex in the paraxial region.

The third lens L3 has a positive refractive power, with the object side surface being concave in the paraxial region and the image side surface being convex in the paraxial region.

The fourth lens L4 has a positive refractive power, with the object side surface being concave in the paraxial region and the image side surface being convex in the paraxial region.

The fifth lens L5 has a negative refractive power, with the object side surface being convex in the paraxial region and the image side surface being concave in the paraxial region.

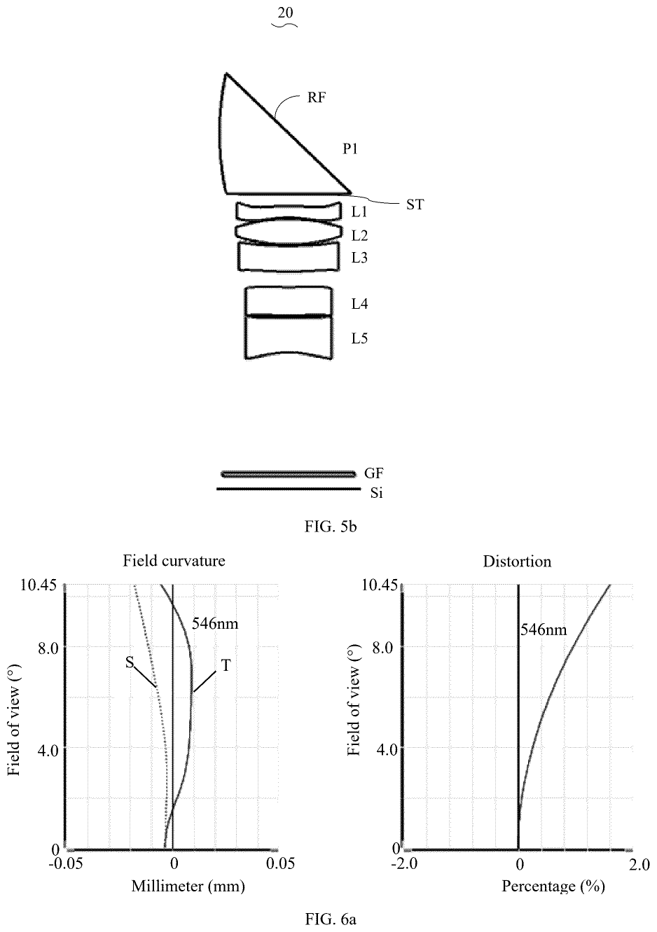

FIG. 5a and FIG. 5b are schematic structural diagrams of the camera optical lens 20 in the first embodiment, and the meanings of the symbols in the second embodiment are the same as the meanings of the symbols in the first embodiment.

Table 4 shows the design data of the camera optical lens 20 in the second embodiment.

TABLE 4

| | R | d | | nd | | vd | |
|---|---|---|---|---|---|---|---|
| ST | ∞ | d0 | −7.369 | / | / | / | / |
| Rp1 | 16.841 | dp1 | 7.346 | nd1 | 1.6188 | vd1 | 63.19 |
| Rp2 | ∞ | dp2 | dp2 | | | | |
| R1 | 8.715 | d1 | 0.672 | nd2 | 1.6153 | vd2 | 25.94 |
| R2 | 5.574 | d2 | 0.097 | | | | |
| R3 | 13.076 | d3 | 1.461 | nd3 | 1.5444 | vd3 | 55.82 |
| R4 | −8.640 | d4 | 0.090 | | | | |
| R5 | −18.336 | d5 | 1.485 | nd4 | 1.6449 | vd4 | 22.54 |
| R6 | −18.092 | d6 | d6 | | | | |
| R7 | −18.574 | d7 | 1.649 | nd5 | 1.6610 | vd5 | 20.53 |
| R8 | −16.585 | d8 | 0.104 | | | | |
| R9 | 13.902 | d9 | 2.010 | nd6 | 1.5346 | vd6 | 55.69 |
| R10 | 4.154 | d10 | 6.956 | | | | |
| R11 | ∞ | d11 | 0.210 | ndg | 1.5168 | vdg | 64.17 |
| R12 | ∞ | d12 | 0.751 | | | | |

Where dp1 = “dp1-01” + “dp1-02”, “dp1-01” = 3.846, “dp1-02” = 3.500.

Table 5 lists the data of relevant optical parameters of the camera optical lens 20 in the first state and the second state respectively according to the second embodiment of the present disclosure.

TABLE 5

| | In the first state | In the second state |
|---|---|---|
| fA | 19.110 | 17.650 |
| FOV | 20.90° | 19.13° |
| FNO | 2.80 | 3.14 |
| dp2 | 1.277 | 0.026 |
| d6 | 0.327 | 1.578 |

Table 6 shows the conic coefficient k and aspheric coefficient of the camera optical lens 20.

TABLE 6

| | Conic | | | | | |
|---|---|---|---|---|---|---|
| | coefficient | Aspheric surface coefficient | | | | |
| | k | A4 | A6 | A8 | A10 | A12 |
| R1 | 2.88666E+00 | −1.48450E−04 | 5.63300E−06 | −2.64060E−06 | 5.92680E−07 | −8.20600E−08 |
| R2 | 0.00000E+00 | 0.00000E+00 | 0.00000E+00 | 0.00000E+00 | 0.00000E+00 | 0.00000E+00 |
| R3 | −3.83410E+01 | −1.09140E−03 | −5.34040E−03 | 2.38900E−03 | −7.64510E−04 | 1.71270E−04 |
| R4 | 1.60672E−01 | 7.81180E−03 | −2.14070E−02 | 1.20890E−02 | −4.23740E−03 | 9.52950E−04 |
| R5 | 1.71973E+01 | 2.01560E−02 | −1.93670E−02 | 1.11690E−02 | −4.00420E−03 | 9.13090E−04 |
| R6 | 6.39255E+00 | −2.38800E−03 | 1.07640E−02 | −7.59470E−03 | 2.92990E−03 | −6.96060E−04 |
| R7 | −1.93560E+01 | −4.31670E−03 | 1.05040E−02 | −8.09690E−03 | 3.32250E−03 | −8.49020E−04 |
| R8 | 3.02306E+01 | 1.47100E−03 | 1.11240E−03 | −8.20410E−04 | 3.60110E−04 | −9.50440E−05 |
| R9 | −1.74602E+02 | 5.01670E−03 | −3.58920E−05 | 4.26750E−05 | −3.30360E−05 | 1.35930E−05 |
| R10 | −8.97453E+01 | 4.43640E−03 | −2.40290E−03 | 2.53290E−03 | −1.29610E−03 | 3.56130E−04 |
| R11 | 3.48344E+01 | −1.35970E−02 | −2.57080E−03 | 2.72350E−03 | −1.27870E−03 | 2.61080E−04 |
| R12 | −7.71922E+00 | −2.75570E−03 | −1.14820E−03 | 7.49420E−04 | −3.48100E−04 | 1.22820E−04 |

| | Conic coefficient | | | | | |
|---|---|---|---|---|---|---|
| | k | A14 | A16 | A18 | A20 | / |
| R1 | 2.88666E+00 | 6.78430E−09 | −3.05740E−10 | 5.75720E−12 | 0.00000E+00 | / |
| R2 | 0.00000E+00 | 0.00000E+00 | 0.00000E+00 | 0.00000E+00 | 0.00000E+00 | / |
| R3 | −3.83410E+01 | −2.59400E−05 | 2.54640E−06 | −1.46490E−07 | 3.74900E−09 | / |
| R4 | 1.60672E−01 | −1.37690E−04 | 1.24290E−05 | −6.40580E−07 | 1.44300E−08 | / |
| R5 | 1.71973E+01 | −1.33630E−04 | 1.21880E−05 | −6.30620E−07 | 1.40670E−08 | / |
| R6 | 6.39255E+00 | 1.03610E−04 | −9.33680E−06 | 4.62510E−07 | −9.60910E−09 | / |
| R7 | −1.93560E+01 | 1.38410E−04 | −1.38800E−05 | 7.75670E−07 | −1.84110E−08 | / |
| R8 | 3.02306E+01 | 1.54460E−05 | −1.40230E−06 | 5.41020E−08 | 0.00000E+00 | / |
| R9 | −1.74602E+02 | −3.01730E−06 | 3.48420E−07 | −1.61940E−08 | 0.00000E+00 | / |
| R10 | −8.97453E+01 | −3.68420E−05 | −5.27550E−06 | 1.70240E−06 | −1.20270E−07 | / |
| R11 | 3.48344E+01 | 1.63960E−05 | −2.00420E−05 | 3.80110E−06 | −2.42890E−07 | / |
| R12 | −7.71922E+00 | −3.07200E−05 | 4.97780E−06 | −4.59880E−07 | 1.81960E−08 | / |

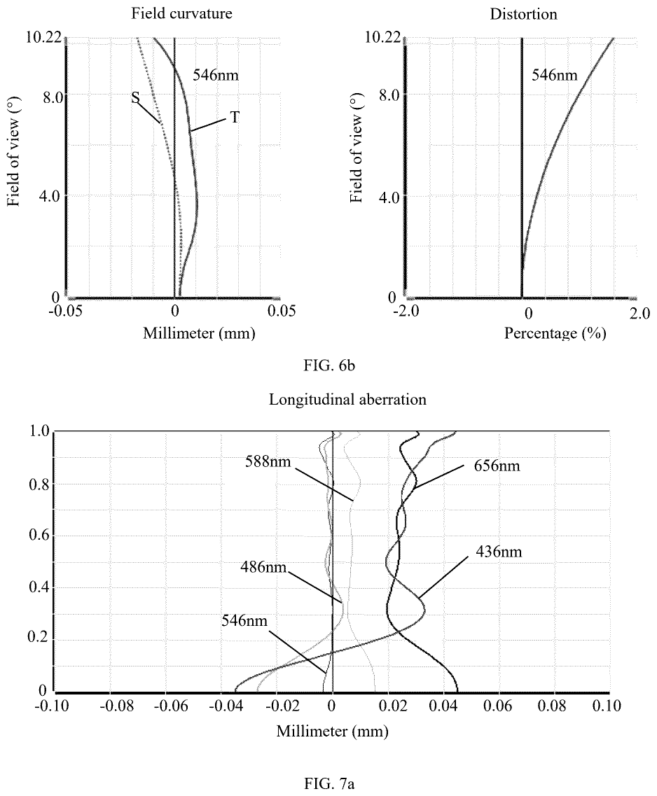

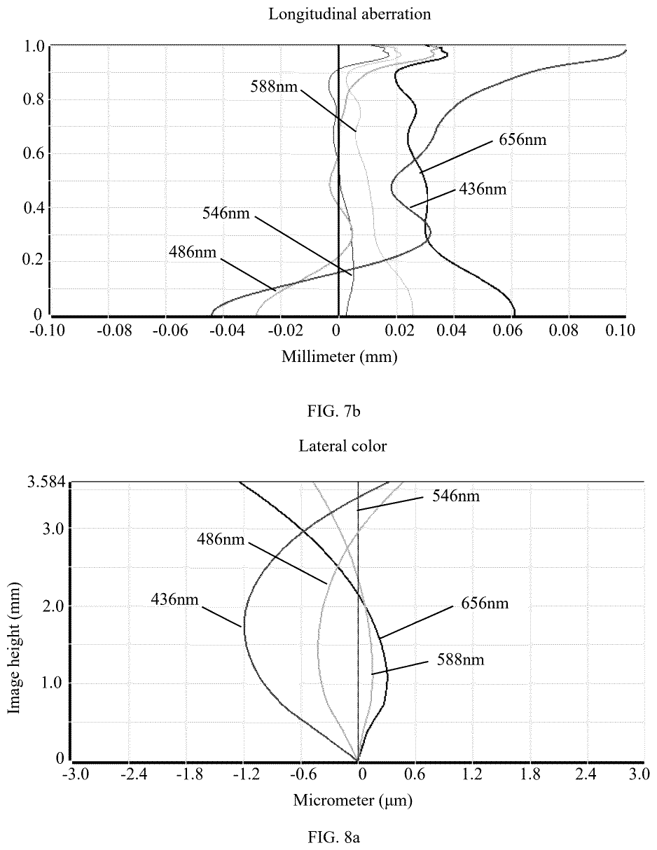

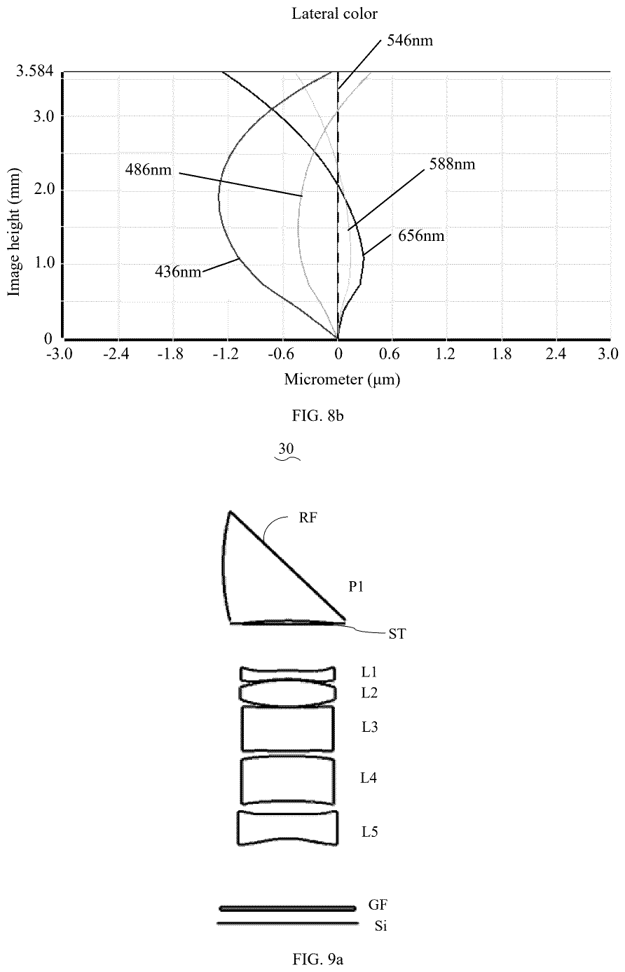

FIG. 6a and FIG. 6b are the schematic diagrams of a field curvature and a distortion after light with a wavelength of 546 nm passes through the camera optical lens 20 of the second embodiment. FIG. 7a and FIG. 7b are the schematic diagrams of a longitudinal aberration after light with wavelengths of 436 nm, 486 nm, 546 nm, 588 nm, and 656 nm pass through the camera optical lens 20 of the second embodiment. FIG. 8a and FIG. 8b are the schematic diagrams of a lateral color after light with wavelengths of 436 nm, 486 nm, 546 nm, 588 nm, and 656 nm pass through the camera optical lens 20 of the second embodiment.

In this embodiment, an entrance pupil diameter ENPD of the camera optical lens 20 in the first state is 6.825 mm, an image height IH is 3.584 mm, and a field of view FOV is 20.90°. The camera optical lens 20 can realize a large-aperture periscope design and has excellent optical performance, and the on-axis and off-axis chromatic aberrations are fully corrected with excellent optical characteristics.

### Third Embodiment

The first prism P1 has a positive refractive power, with the object side surface being convex in the paraxial region and the image side surface being concave in the paraxial region.

The first lens L1 has a negative refractive power, with the object side surface being convex in the paraxial region and the image side surface being concave in the paraxial region.

The second lens L2 has a positive refractive power, with the object side surface being convex in the paraxial region and the image side surface being convex in the paraxial region.

The third lens L3 has a negative refractive power, with the object side surface being concave in the paraxial region and the image side surface being convex in the paraxial region.

The fourth lens L4 has a negative refractive power, with the object side surface being convex in the paraxial region and the image side surface being concave in the paraxial region.

The fifth lens L5 has a negative refractive power, with the object side surface being convex in the paraxial region and the image side surface being concave in the paraxial region.

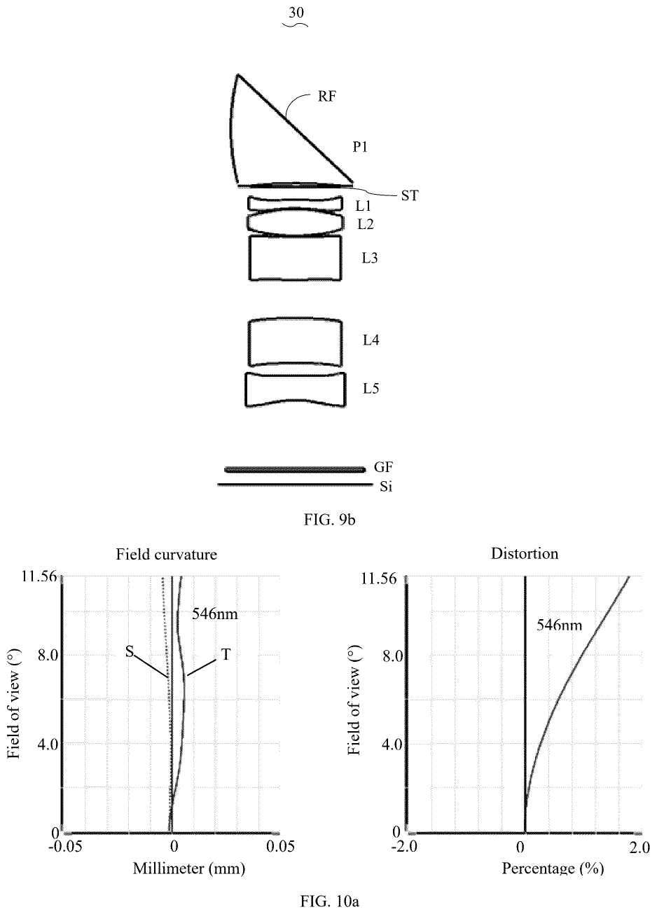

FIG. 9a and FIG. 9b are schematic structural diagrams of the camera optical lens 30 in the third embodiment, and the meanings of the symbols in the third embodiment are the same as the meanings of the symbols in the first embodiment.

Table 7 shows the design data of the camera optical lens 30 in the third embodiment.

TABLE 7

| | R | d | | nd | | vd | |
|---|---|---|---|---|---|---|---|
| ST | ∞ | d0 | −6.912 | / | / | / | / |
| Rp1 | 13.445 | dp1 | 6.717 | nd1 | 1.6188 | vd1 | 63.19 |
| Rp2 | 19.772 | dp2 | dp2 | | | | |
| R1 | 13.396 | d1 | 0.500 | nd2 | 1.6153 | vd2 | 25.94 |
| R2 | 8.058 | d2 | 0.056 | | | | |
| R3 | 11.324 | d3 | 1.551 | nd3 | 1.5444 | vd3 | 55.82 |
| R4 | −7.584 | d4 | 0.050 | | | | |
| R5 | −26.395 | d5 | 2.500 | nd4 | 1.6449 | vd4 | 22.54 |
| R6 | −51.751 | d6 | d6 | | | | |
| R7 | 24.263 | d7 | 2.603 | nd5 | 1.6610 | vd5 | 20.53 |
| R8 | 22.985 | d8 | 0.743 | | | | |
| R9 | 13.960 | d9 | 1.428 | nd6 | 1.5346 | vd6 | 55.69 |
| R10 | 4.409 | d10 | 3.966 | | | | |
| R11 | ∞ | d11 | 0.210 | ndg | 1.5168 | vdg | 64.17 |
| R12 | ∞ | d12 | 0.751 | | | | |

Where dp1 = “dp1-01” + “dp1-02”, “dp1-01” = 3.540, “dp1-02” = 3.177.

Table 8 lists the data of relevant optical parameters of the camera optical lens 30 in the first state and the second state respectively according to the third embodiment of the present disclosure.

TABLE 8

| | In the first state | In the second state |
|---|---|---|
| fA | 17.218 | 14.089 |
| FOV | 23.11° | 20.97° |
| FNO | 2.80 | 3.17 |
| dp2 | 2.889 | 0.963 |
| d6 | 0.306 | 2.232 |

Table 9 shows the conic coefficient k and aspheric coefficient of the camera optical lens 30.

TABLE 9

| | Conic | | | | | |
|---|---|---|---|---|---|---|
| | coefficient | Aspheric surface coefficient | | | | |
| | k | A4 | A6 | A8 | A10 | A12 |
| R1 | 2.88494E+00 | −1.75240E−04 | 3.64990E−06 | −2.66620E−06 | 6.69780E−07 | −1.02680E−07 |
| R2 | 0.00000E+00 | 0.00000E+00 | 0.00000E+00 | 0.00000E+00 | 0.00000E+00 | 0.00000E+00 |
| R3 | −5.66702E+01 | −5.69790E−03 | −5.66870E−03 | 3.43960E−03 | −1.25970E−03 | 3.08380E−04 |
| R4 | 3.45684E+00 | 2.09170E−02 | −3.77670E−02 | 2.39340E−02 | −9.20620E−03 | 2.23470E−03 |
| R5 | 1.56587E+01 | 3.32390E−02 | −3.64690E−02 | 2.29770E−02 | −8.94790E−03 | 2.20050E−03 |
| R6 | 5.98791E+00 | 2.13520E−03 | 6.19460E−03 | −5.19370E−03 | 2.31130E−03 | −6.34710E−04 |
| R7 | −5.46984E+01 | 6.75390E−04 | 5.64940E−03 | −5.14490E−03 | 2.40290E−03 | −7.05510E−04 |
| R8 | 1.54479E+02 | 1.82670E−03 | 2.77690E−04 | −1.54280E−04 | 5.92180E−05 | −1.43840E−05 |
| R9 | −1.84250E+02 | 3.24190E−03 | −2.25760E−04 | 4.58950E−05 | −1.46180E−05 | 4.64930E−06 |
| R10 | −1.72246E+02 | 2.08990E−03 | 2.05430E−04 | −1.13400E−04 | 8.65850E−05 | −4.31770E−05 |
| R11 | 2.72788E+01 | −1.53540E−02 | 1.17380E−03 | −3.43680E−04 | 1.81160E−04 | −7.92060E−05 |
| R12 | −6.92076E+00 | −5.68740E−03 | −1.47450E−05 | 1.91640E−04 | −8.35280E−05 | 2.37430E−05 |

| | Conic coefficient | | | | | |
|---|---|---|---|---|---|---|
| | k | A14 | A16 | A18 | A20 | / |
| R1 | 2.88494E+00 | 9.38960E−09 | −4.73340E−10 | 1.01260E−11 | 0.00000E+00 | / |
| R2 | 0.00000E+00 | 0.00000E+00 | 0.00000E+00 | 0.00000E+00 | 0.00000E+00 | / |
| R3 | −5.66702E+01 | −5.19420E−05 | 6.03220E−06 | −4.42990E−07 | 1.52460E−08 | / |
| R4 | 3.45684E+00 | −3.45190E−04 | 3.33080E−05 | −1.86200E−06 | 4.68670E−08 | / |
| R5 | 1.56587E+01 | −3.45970E−04 | 3.41030E−05 | −1.94230E−06 | 4.90620E−08 | / |
| R6 | 5.98791E+00 | 1.08140E−04 | −1.08010E−05 | 5.57580E−07 | −1.06420E−08 | / |
| R7 | −5.46984E+01 | 1.32600E−04 | −1.52690E−05 | 9.70870E−07 | −2.58880E−08 | / |
| R8 | 1.54479E+02 | 2.32040E−06 | −2.22020E−07 | 9.33650E−09 | 0.00000E+00 | / |
| R9 | −1.84250E+02 | −9.23890E−07 | 9.81220E−08 | −4.27810E−09 | 0.00000E+00 | / |
| R10 | −1.72246E+02 | 1.37090E−05 | −2.64380E−06 | 2.82700E−07 | −1.27830E−08 | / |
| R11 | 2.72788E+01 | 2.25380E−05 | −3.99450E−06 | 3.98890E−07 | −1.71660E−08 | / |
| R12 | −6.92076E+00 | −4.55640E−06 | 5.54610E−07 | −3.82870E−08 | 1.13760E−09 | / |

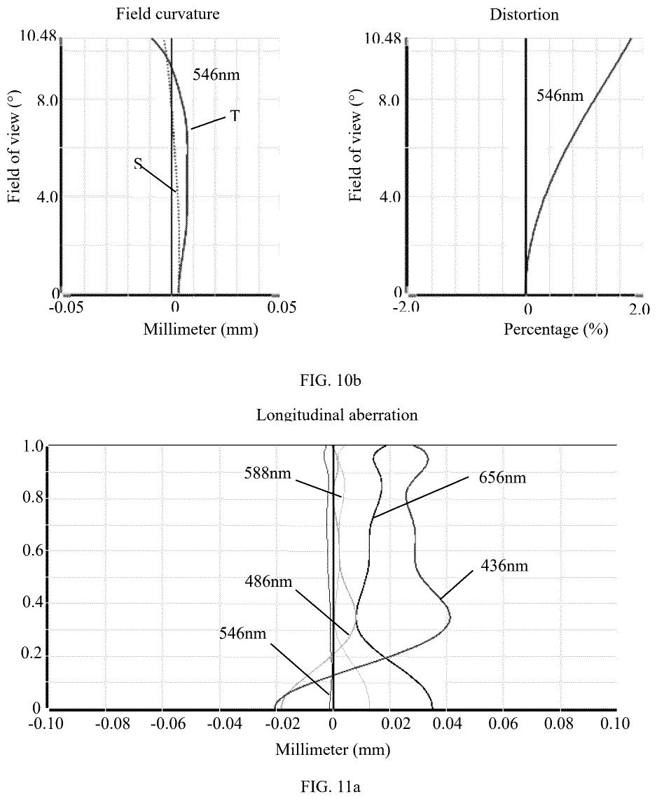

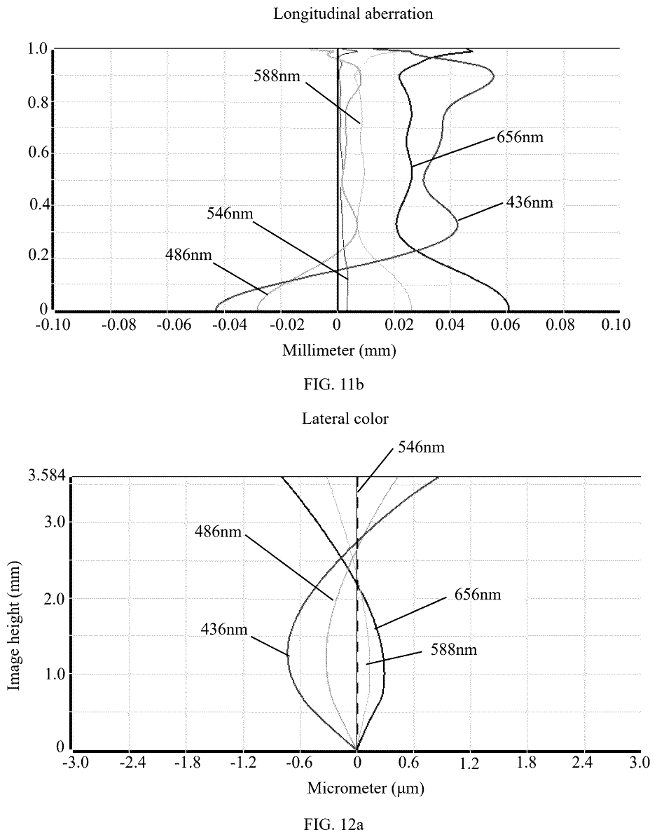

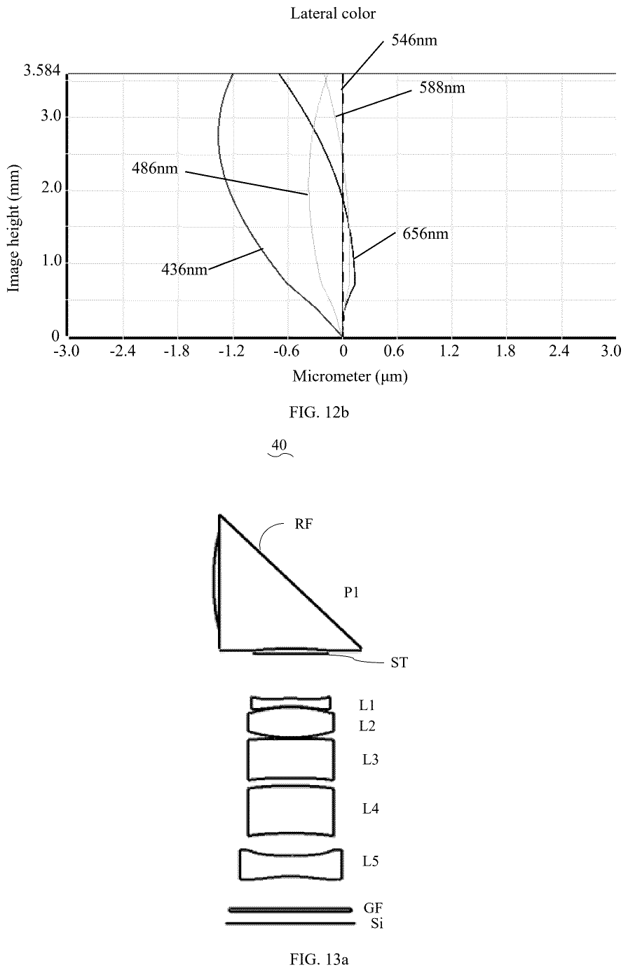

FIG. 10a and FIG. 10b are the schematic diagrams of a field curvature and a distortion after light with a wavelength of 546 nm passes through the camera optical lens 30 of the third embodiment. FIG. 11a and FIG. 11b are the schematic diagrams of a longitudinal aberration after light with wavelengths of 436 nm, 486 nm, 546 nm, 588 nm, and 656 nm pass through the camera optical lens 30 of the third embodiment. FIG. 12a and FIG. 12b are the schematic diagrams of a lateral color after light with wavelengths of 436 nm, 486 nm, 546 nm, 588 nm, and 656 nm pass through the camera optical lens 30 of the third embodiment.

In this embodiment, an entrance pupil diameter ENPD of the camera optical lens 30 in the first state is 6.149 mm, an image height IH is 3.584 mm, and a field of view FOV is 23.11°. The camera optical lens 30 can realize a large-aperture periscope design and has excellent optical performance, and the on-axis and off-axis chromatic aberrations are fully corrected with excellent optical characteristics.

### Fourth Embodiment

The first prism P1 has a positive refractive power, with the object side surface being convex in the paraxial region and the image side surface being concave in the paraxial region.

The first lens L1 has a negative refractive power, with the object side surface being convex in the paraxial region and the image side surface being concave in the paraxial region.

The second lens L2 has a positive refractive power, with the object side surface being convex in the paraxial region and the image side surface being convex in the paraxial region.

The third lens L3 has a negative refractive power, with the object side surface being convex in the paraxial region and the image side surface being concave in the paraxial region.

The fourth lens L4 has a positive refractive power, with the object side surface being convex in the paraxial region and the image side surface being concave in the paraxial region.

The fifth lens L5 has a negative refractive power, with the object side surface being concave in the paraxial region and the image side surface being concave in the paraxial region.

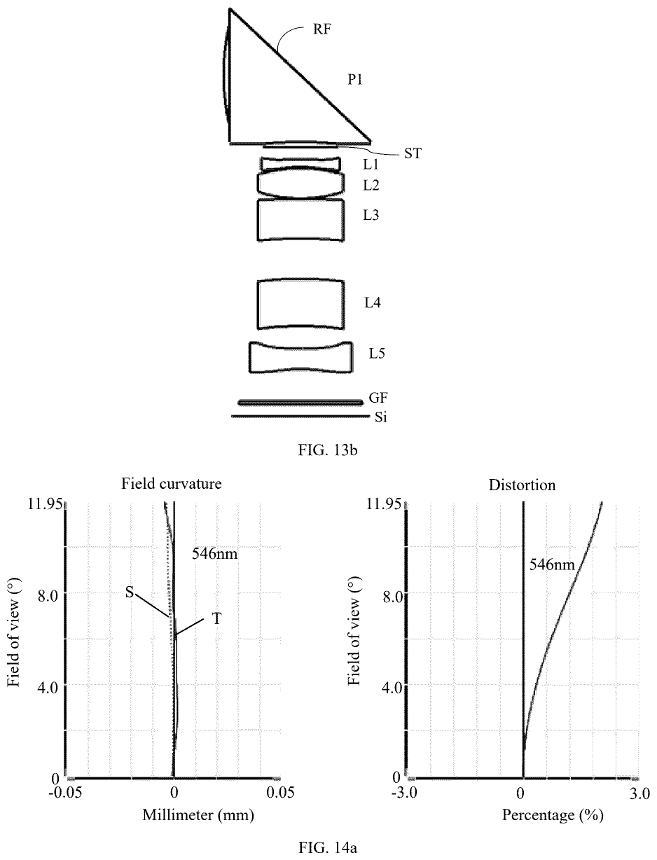

FIG. 13a and FIG. 13b are schematic structural diagrams of the camera optical lens 40 in the fourth embodiment, and the meanings of the symbols in the fourth embodiment are the same as the meanings of the symbols in the first embodiment.

Table 10 shows the design data of the camera optical lens 40 in the fourth embodiment.

TABLE 10

| | R | d | | nd | | Vd | |
|---|---|---|---|---|---|---|---|
| ST | ∞ | d0 | −9.203 | / | / | / | / |
| Rp1 | 14.753 | dp1 | 8.878 | nd1 | 1.6188 | vd1 | 63.19 |
| Rp2 | 20.490 | dp2 | dp2 | | | | |
| R1 | 14.157 | d1 | 0.500 | nd2 | 1.6153 | vd2 | 25.94 |
| R2 | 7.193 | d2 | 0.059 | | | | |
| R3 | 10.126 | d3 | 1.933 | nd3 | 1.5444 | vd3 | 55.82 |
| R4 | −7.129 | d4 | 0.050 | | | | |
| R5 | 310.629 | d5 | 2.500 | nd4 | 1.6449 | vd4 | 22.54 |
| R6 | 44.949 | d6 | d6 | | | | |
| R7 | 24.420 | d7 | 3.000 | nd5 | 1.6610 | vd5 | 20.53 |
| R8 | 24.412 | d8 | 1.420 | | | | |
| R9 | −47.837 | d9 | 1.311 | nd6 | 1.5346 | vd6 | 55.69 |
| R10 | 7.285 | d10 | 2.039 | | | | |
| R11 | ∞ | d11 | 0.210 | ndg | 1.5168 | vdg | 64.17 |
| R12 | ∞ | d12 | 0.751 | | | | |

Where dp1 = “dp1-01” + “dp1-02”, “dp1-01” = 4.619, “dp1-02” = 4.259.

Table 11 lists the data of relevant optical parameters of the camera optical lens 40 in the first state and the second state respectively according to the fourth embodiment of the present disclosure.

TABLE 11

| | In the first state | In the second state |
|---|---|---|
| fA | 16.587 | 14.120 |
| FOV | 23.91° | 21.71° |
| FNO | 2.80 | 3.13 |
| dp2 | 3.165 | 1.234 |
| d6 | 0.500 | 2.431 |

Table 12 shows the conic coefficient k and aspheric coefficient of the camera optical lens 40.

TABLE 12

| | Conic | | | | | |
|---|---|---|---|---|---|---|
| | coefficient | Aspheric surface coefficient | | | | |
| | k | A4 | A6 | A8 | A10 | A12 |
| R1 | 3.21218E+00 | −1.34290E−04 | −1.41260E−06 | −2.68910E−07 | 9.65460E−08 | −1.77320E−08 |
| R2 | 0.00000E+00 | 0.00000E+00 | 0.00000E+00 | 0.00000E+00 | 0.00000E+00 | 0.00000E+00 |
| R3 | −3.97087E+01 | −5.64520E−03 | −6.15310E−03 | 4.56320E−03 | −2.04970E−03 | 6.25650E−04 |
| R4 | 3.65375E+00 | 1.94430E−02 | −3.67370E−02 | 2.43530E−02 | −9.82850E−03 | 2.52840E−03 |
| R5 | 1.36473E+01 | 2.98190E−02 | −3.42040E−02 | 2.18260E−02 | −8.54620E−03 | 2.08910E−03 |
| R6 | 5.39941E+00 | 4.26500E−03 | 3.19900E−03 | −2.97290E−03 | 1.34200E−03 | −3.58980E−04 |
| R7 | 1.99000E+02 | 2.61410E−03 | 3.02330E−03 | −3.10860E−03 | 1.48170E−03 | −4.36050E−04 |
| R8 | −1.07353E+02 | 1.46570E−03 | 3.20870E−04 | −1.87330E−04 | 7.16690E−05 | −1.88010E−05 |
| R9 | −1.36544E+02 | 1.99340E−03 | −1.37920E−04 | 4.61780E−05 | −2.20920E−05 | 7.14910E−06 |
| R10 | −1.33603E+00 | 1.03460E−03 | −4.27010E−05 | 2.27120E−05 | 4.24840E−06 | −8.95020E−06 |
| R11 | −1.76540E+02 | −7.80260E−03 | 5.30170E−04 | −3.91520E−04 | 2.73520E−04 | −1.16160E−04 |
| R12 | −2.57996E+00 | −6.89620E−03 | 3.33560E−04 | −1.37900E−06 | 1.87370E−06 | −3.09740E−06 |

| | Conic coefficient | | | | | |
|---|---|---|---|---|---|---|
| | k | A14 | A16 | A18 | A20 | / |
| R1 | 3.21218E+00 | 1.69620E−09 | −8.21190E−11 | 1.59350E−12 | 0.00000E+00 | / |
| R2 | 0.00000E+00 | 0.00000E+00 | 0.00000E+00 | 0.00000E+00 | 0.00000E+00 | / |
| R3 | −3.97087E+01 | −1.30930E−04 | 1.81240E−05 | −1.49190E−06 | 5.47060E−08 | / |
| R4 | 3.65375E+00 | −4.21380E−04 | 4.50370E−05 | −2.88160E−06 | 8.54350E−08 | / |
| R5 | 1.36473E+01 | −3.20940E−04 | 3.02350E−05 | −1.60680E−06 | 3.66950E−08 | / |
| R6 | 5.39941E+00 | 5.70830E−05 | −4.86540E−06 | 1.61930E−07 | 9.76460E−10 | / |
| R7 | 1.99000E+02 | 8.09520E−05 | −9.05860E−06 | 5.47910E−07 | −1.34810E−08 | / |
| R8 | −1.07353E+02 | 3.26850E−06 | −3.25600E−07 | 1.37360E−08 | 0.00000E+00 | / |
| R9 | −1.36544E+02 | −1.33200E−06 | 1.32590E−07 | −5.46680E−09 | 0.00000E+00 | / |
| R10 | −1.33603E+00 | 4.01090E−06 | −8.71930E−07 | 9.59410E−08 | −4.26660E−09 | / |
| R11 | −1.76540E+02 | 2.97600E−05 | −4.52470E−06 | 3.76640E−07 | −1.32210E−08 | / |
| R12 | −2.57996E+00 | 9.31030E−07 | −1.30350E−07 | 9.06170E−09 | −2.52860E−10 | / |

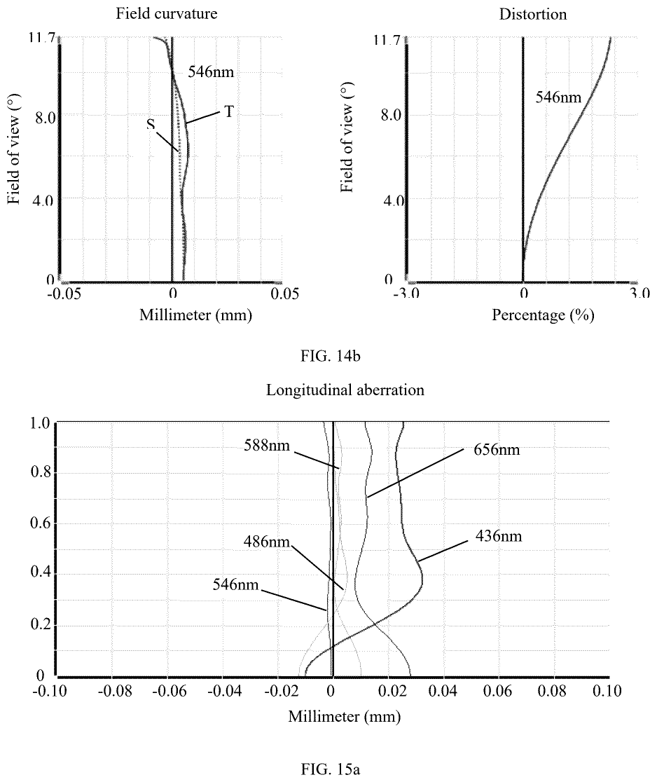

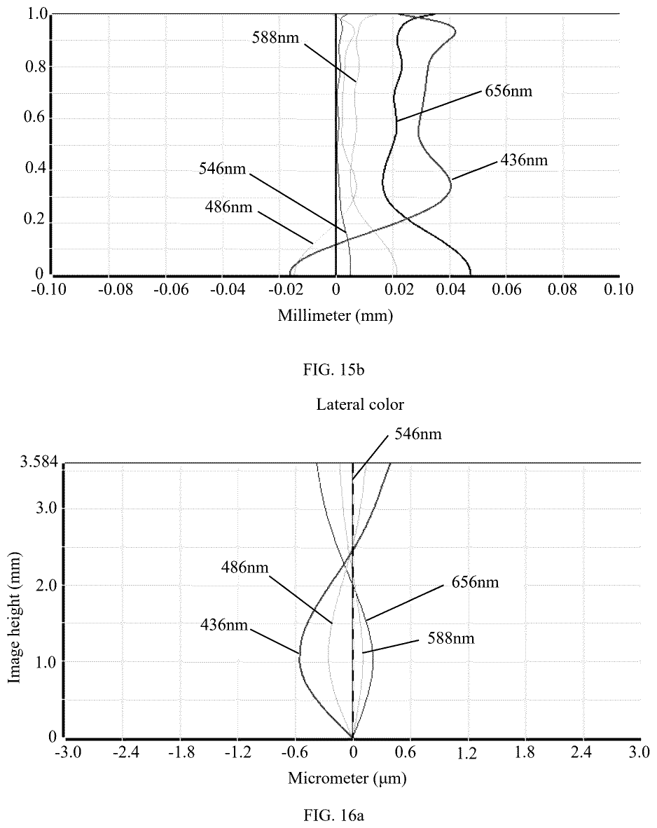

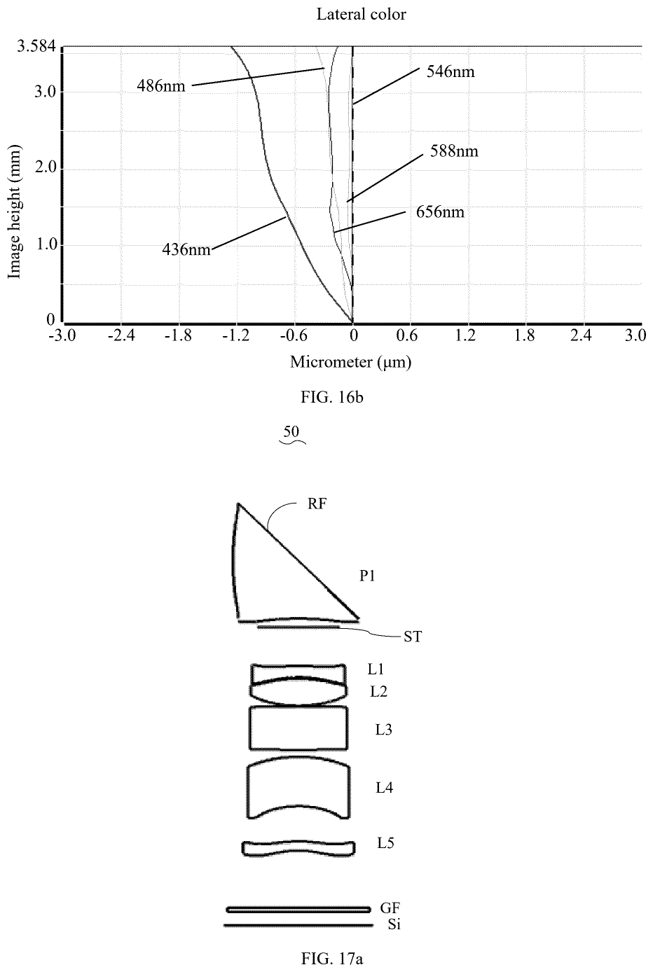

FIG. 14a and FIG. 14b are the schematic diagrams of a field curvature and a distortion after light with a wavelength of 546 nm passes through the camera optical lens 40 of the fourth embodiment. FIG. 15a and FIG. 15b are the schematic diagrams of a longitudinal aberration after light with wavelengths of 436 nm, 486 nm, 546 nm, 588 nm, and 656 nm pass through the camera optical lens 40 of the fourth embodiment. FIG. 16a and FIG. 16b are the schematic diagrams of a lateral color after light with wavelengths of 436 nm, 486 nm, 546 nm, 588 nm, and 656 nm pass through the camera optical lens 40 of the fourth embodiment.

In this embodiment, an entrance pupil diameter ENPD of the camera optical lens 40 in the first state is 5.924 mm, an image height IH is 3.584 mm, and a field of view FOV is 23.91°. The camera optical lens 40 can realize a large-aperture periscope design and has excellent optical performance, and the on-axis and off-axis chromatic aberrations are fully corrected with excellent optical characteristics.

### Fifth Embodiment

The first prism P1 has a positive refractive power, with the object side surface being convex in the paraxial region and the image side surface being concave in the paraxial region.

The first lens L1 has a negative refractive power, with the object side surface being convex in the paraxial region and the image side surface being concave in the paraxial region.

The second lens L2 has a positive refractive power, with the object side surface being convex in the paraxial region and the image side surface being convex in the paraxial region.

The third lens L3 has a positive refractive power, with the object side surface being concave in the paraxial region and the image side surface being convex in the paraxial region.

The fourth lens LA has a negative refractive power, with the object side surface being convex in the paraxial region and the image side surface being concave in the paraxial region.

The fifth lens L5 has a negative refractive power, with the object side surface being convex in the paraxial region and the image side surface being concave in the paraxial region.

FIG. 17a and FIG. 17b are schematic structural diagrams of the camera optical lens 50 in the fifth embodiment, and the meanings of the symbols in the fifth embodiment are the same as the meanings of the symbols in the first embodiment.

Table 13 shows the design data of the camera optical lens 50 in the fifth embodiment.

TABLE 13

| | R | d | | nd | | vd | |
|---|---|---|---|---|---|---|---|
| ST | ∞ | d0 | −7.007 | / | / | / | / |
| Rp1 | 15.084 | dp1 | 6.552 | nd1 | 1.6188 | vd1 | 63.19 |
| Rp2 | 14.788 | dp2 | dp2 | | | | |
| R1 | 13.569 | d1 | 0.603 | nd2 | 1.6153 | vd2 | 25.94 |
| R2 | 5.631 | d2 | 0.095 | | | | |
| R3 | 8.538 | d3 | 1.462 | nd3 | 1.5444 | vd3 | 55.82 |
| R4 | −6.004 | d4 | 0.063 | | | | |
| R5 | −24.217 | d5 | 2.352 | nd4 | 1.6449 | vd4 | 22.54 |
| R6 | −24.657 | d6 | d6 | | | | |
| R7 | 7.180 | d7 | 2.675 | nd5 | 1.6610 | vd5 | 20.53 |
| R8 | 4.755 | d8 | 1.908 | | | | |
| R9 | 5.200 | d9 | 0.500 | nd6 | 1.5346 | vd6 | 55.69 |
| R10 | 3.751 | d10 | 3.127 | | | | |
| R11 | ∞ | d11 | 0.210 | ndg | 1.5168 | vdg | 64.17 |
| R12 | ∞ | d12 | 0.751 | | | | |

Where dp1 = “dp1-01” + “dp1-02”, “dp1-01” = 3.406, “dp1-02” = 3.146.

Table 14 lists the data of relevant optical parameters of the camera optical lens 50 in the first state and the second state respectively according to the fifth embodiment of the present disclosure.

TABLE 14

| | In the first state | In the second state |
|---|---|---|
| fA | 14.515 | 12.960 |
| FOV | 27.19° | 25.31° |
| FNO | 2.80 | 3.16 |
| dp2 | 2.575 | 0.625 |
| d6 | 0.369 | 2.319 |

Table 15 shows the conic coefficient k and aspheric coefficient of the camera optical lens 50.

TABLE 15

| | Conic | | | | | |
|---|---|---|---|---|---|---|
| | coefficient | Aspheric surface coefficient | | | | |
| | k | A4 | A6 | A8 | A10 | A12 |
| R1 | 3.13796E+00 | −1.48760E−04 | −2.17320E−06 | 1.36670E−06 | −6.20860E−07 | 1.32940E−07 |
| R2 | 0.00000E+00 | 0.00000E+00 | 0.00000E+00 | 0.00000E+00 | 0.00000E+00 | 0.00000E+00 |
| R3 | −2.11901E+01 | −2.95830E−03 | −8.10790E−03 | 6.70040E−03 | −3.40760E−03 | 1.10330E−03 |
| R4 | 3.44769E+00 | 2.41000E−02 | −4.22580E−02 | 3.00340E−02 | −1.27710E−02 | 3.23660E−03 |
| R5 | 9.92642E+00 | 2.92910E−02 | −3.75050E−02 | 2.44680E−02 | −9.22010E−03 | 1.84950E−03 |
| R6 | 4.08359E+00 | 7.00790E−03 | −1.62670E−03 | 2.40800E−04 | 6.99770E−05 | −4.94840E−05 |
| R7 | −1.61147E+02 | 5.59180E−03 | −1.36760E−04 | −5.56480E−04 | 3.33450E−04 | −1.12530E−04 |
| R8 | −5.54226E+01 | 1.35020E−03 | 3.82340E−04 | −1.66740E−04 | 5.49540E−05 | −1.16220E−05 |
| R9 | −2.33266E+01 | 8.53600E−03 | −1.48080E−03 | 3.33090E−04 | −6.34430E−05 | 8.90120E−06 |
| R10 | 1.14014E+00 | 5.25640E−04 | 8.42290E−05 | 1.67070E−04 | −1.57040E−04 | 8.74860E−05 |
| R11 | −1.08326E+01 | −9.62370E−03 | −8.77650E−04 | 6.70530E−04 | −2.24530E−04 | 5.00660E−05 |
| R12 | −3.90147E+00 | −1.38100E−02 | 3.17120E−04 | 4.34490E−04 | −2.02070E−04 | 5.22470E−05 |

| | Conic coefficient | | | | | |
|---|---|---|---|---|---|---|
| | k | A14 | A16 | A18 | A20 | / |
| R1 | 3.13796E+00 | −1.53820E−08 | 9.30260E−10 | −2.31450E−11 | 0.00000E+00 | / |
| R2 | 0.00000E+00 | 0.00000E+00 | 0.00000E+00 | 0.00000E+00 | 0.00000E+00 | / |
| R3 | −2.11901E+01 | −2.25930E−04 | 2.81040E−05 | −1.91880E−06 | 5.42320E−08 | / |
| R4 | 3.44769E+00 | −4.62450E−04 | 2.97490E−05 | 1.97890E−07 | −8.63490E−08 | / |
| R5 | 9.92642E+00 | −1.28300E−04 | −1.86620E−05 | 4.06410E−06 | −2.16950E−07 | / |
| R6 | 4.08359E+00 | 1.21010E−05 | −1.27300E−06 | 3.03790E−08 | 2.83140E−09 | / |
| R7 | −1.61147E+02 | 2.42140E−05 | −3.22800E−06 | 2.43140E−07 | −7.90700E−09 | / |
| R8 | −5.54226E+01 | 1.51190E−06 | −1.08710E−07 | 3.37160E−09 | 0.00000E+00 | / |
| R9 | −2.33266E+01 | −8.00930E−07 | 3.89080E−08 | −7.39470E−10 | 0.00000E+00 | / |
| R10 | 1.14014E+00 | −2.92250E−05 | 5.80200E−06 | −6.25760E−07 | 2.78210E−08 | / |
| R11 | −1.08326E+01 | −6.94780E−06 | 5.03090E−07 | −8.15290E−09 | −7.04560E−10 | / |
| R12 | −3.90147E+00 | −8.52170E−06 | 8.47850E−07 | −4.62600E−08 | 1.03310E−09 | / |

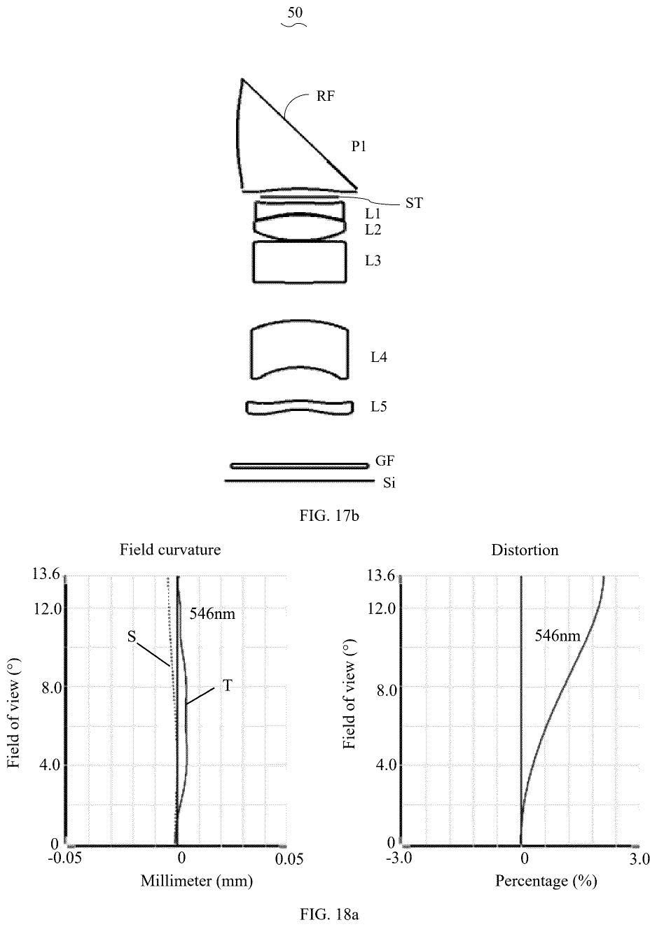

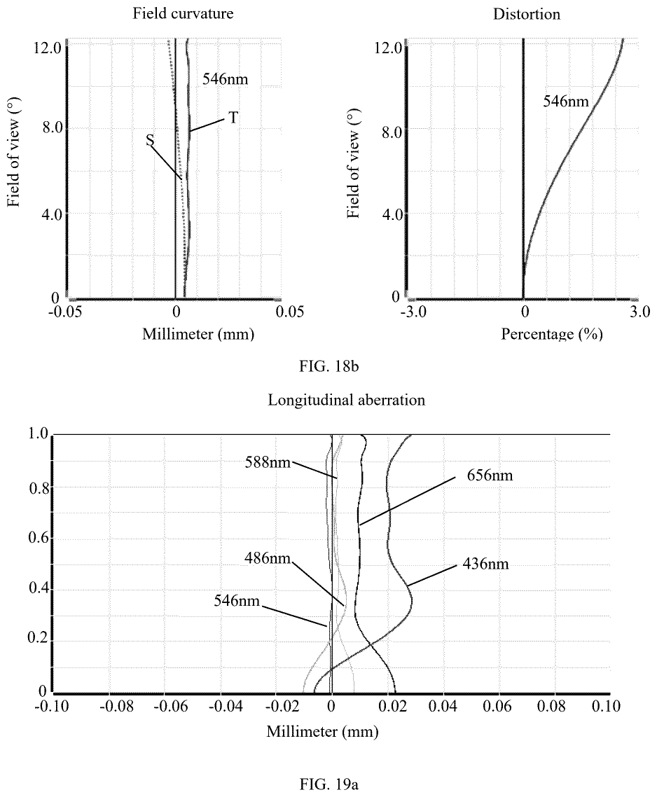

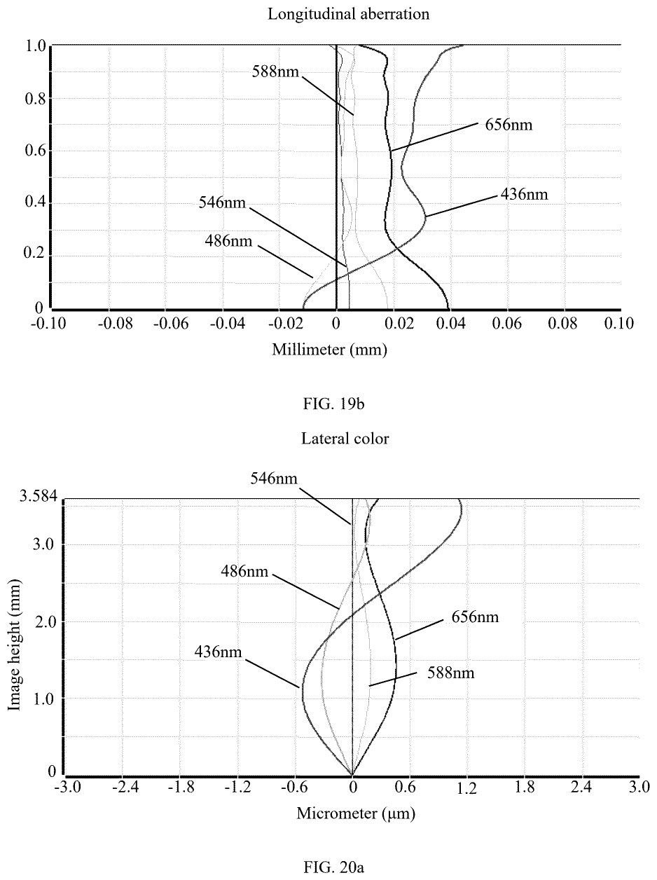

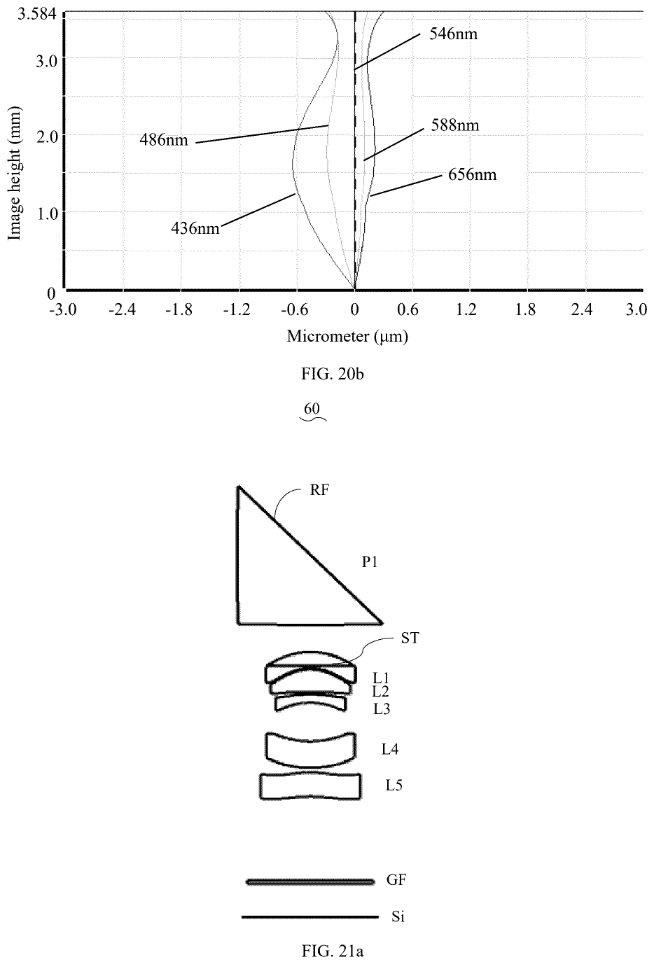

FIG. 18a and FIG. 18b are the schematic diagrams of a field curvature and a distortion after light with a wavelength of 546 nm passes through the camera optical lens 50 of the fifth embodiment. FIG. 19a and FIG. 19b are the schematic diagrams of a longitudinal aberration after light with wavelengths of 436 nm, 486 nm, 546 nm, 588 nm, and 656 nm pass through the camera optical lens 50 of the fifth embodiment. FIG. 20a and FIG. 20b are the schematic diagrams of a lateral color after light with wavelengths of 436 nm, 486 nm, 546 nm, 588 nm, and 656 nm pass through the camera optical lens 50 of the fifth embodiment.

In this embodiment, an entrance pupil diameter ENPD of the camera optical lens 50 in the first state is 5.184 mm, an image height IH is 3.584 mm, and a field of view FOV is 27.19°. The camera optical lens 50 can realize a large-aperture periscope design and has excellent optical performance, and the on-axis and off-axis chromatic aberrations are fully corrected with excellent optical characteristics.

### Sixth Embodiment

The first prism P1 has a positive refractive power, with the object side surface being convex in the paraxial region and the image side surface being concave in the paraxial region.

The first lens L1 has a negative refractive power, with the object side surface being convex in the paraxial region and the image side surface being concave in the paraxial region.

The second lens L2 has a positive refractive power, with the object side surface being convex in the paraxial region and the image side surface being concave in the paraxial region.

The third lens L3 has a negative refractive power, with the object side surface being convex in the paraxial region and the image side surface being concave in the paraxial region.

The fourth lens LA has a negative refractive power, with the object side surface being concave in the paraxial region and the image side surface being convex in the paraxial region.

The fifth lens L5 has a positive refractive power, with the object side surface being convex in the paraxial region and the image side surface being concave in the paraxial region.

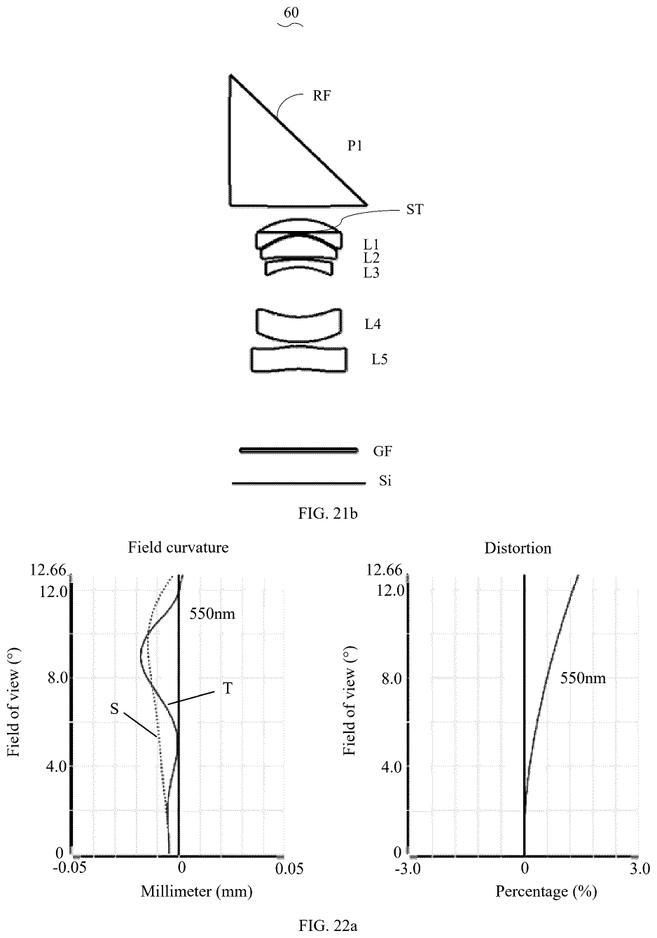

FIG. 21a and FIG. 21b are schematic structural diagrams of the camera optical lens 60 in the sixth embodiment, and the meanings of the symbols in the sixth embodiment are the same as the meanings of the symbols in the first embodiment.

Table 16 shows the design data of the camera optical lens 60 in the sixth embodiment.

TABLE 16

| | R | d | | nd | | vd | |
|---|---|---|---|---|---|---|---|
| ST | ∞ | d0 | d0 | / | / | / | / |
| Rp1 | 100.002 | dp1 | 8.314 | nd1 | 1.5168 | vd1 | 64.17 |
| Rp2 | −111.114 | dp2 | dp2 | | | | |
| R1 | 3.979 | d1 | 0.938 | nd2 | 1.5444 | vd2 | 55.82 |
| R2 | 2.141 | d2 | 0.088 | | | | |
| R3 | 2.209 | d3 | 1.359 | nd3 | 1.5444 | vd3 | 55.82 |
| R4 | 26.882 | d4 | 0.130 | | | | |
| R5 | 5.907 | d5 | 0.488 | nd4 | 1.6400 | vd4 | 23.54 |
| R6 | 3.240 | d6 | d6 | | | | |
| R7 | −4.209 | d7 | 1.561 | nd5 | 1.6610 | vd5 | 20.53 |
| R8 | −8.018 | d8 | 0.270 | | | | |
| R9 | 4.558 | d9 | 1.436 | nd6 | 1.6153 | vd6 | 25.94 |
| R10 | 7.559 | d10 | 5.000 | | | | |
| R11 | ∞ | d11 | 0.210 | ndg | 1.5168 | vdg | 64.17 |
| R12 | ∞ | d12 | 1.972 | | | | |

Where dp1 = “dp1-01” + “dp1-02”, “dp1-01” = 4.172, “dp1-02” = 4.142.

Table 17 lists the data of relevant optical parameters of the camera optical lens 60 in the first state and the second state respectively according to the sixth embodiment of the present disclosure.

TABLE 17

| | In the first state | In the second state |
|---|---|---|
| fA | 15.724 | 13.040 |
| FOV | 25.32° | 22.45° |
| FNO | 2.95 | 3.02 |
| d0 | 10.744 | 9.331 |
| dp2 | 1.616 | 0.203 |
| d6 | 2.311 | 3.724 |

Table 18 shows the conic coefficient k and aspheric coefficient of the camera optical lens 60.

TABLE 18

| | Conic | | | | | |
|---|---|---|---|---|---|---|
| | coefficient | Aspheric surface coefficient | | | | |
| | k | A4 | A6 | A8 | A10 | A12 |
| R1 | −2.08955E+02 | −1.54330E−05 | −3.58530E−08 | −2.92440E−08 | 3.09210E−09 | −9.18700E−11 |
| R2 | 0.00000E+00 | 0.00000E+00 | 0.00000E+00 | 0.00000E+00 | 0.00000E+00 | 0.00000E+00 |
| R3 | −5.34619E−02 | −2.12770E−03 | 5.68900E−04 | −1.20960E−04 | 2.77690E−05 | −6.86080E−06 |
| R4 | −3.43979E+00 | 2.01310E−03 | −1.97540E−03 | 3.74310E−03 | −1.92250E−03 | 4.73290E−04 |
| R5 | −3.44643E+00 | 2.07670E−03 | −1.70310E−03 | 3.55710E−03 | −1.56640E−03 | 2.68300E−04 |
| R6 | −1.24037E+02 | −3.02930E−02 | 3.36560E−02 | −1.78550E−02 | 5.84470E−03 | −1.25650E−03 |
| R7 | −1.73927E+00 | −4.05330E−02 | 3.72380E−02 | −1.94340E−02 | 5.12170E−03 | −3.70790E−04 |
| R8 | 1.13325E−01 | −1.80990E−02 | 1.07730E−02 | −4.68990E−03 | −5.32090E−04 | 1.51890E−03 |
| R9 | 2.30539E−01 | 7.95630E−03 | −4.85250E−04 | −7.39220E−04 | 9.61110E−04 | −5.94630E−04 |
| R10 | 5.56813E+00 | −1.92500E−02 | 9.30170E−03 | −3.15510E−03 | 7.82470E−04 | −1.30130E−04 |
| R11 | −7.07356E+00 | −2.26820E−02 | 7.85590E−03 | −2.63880E−03 | 6.43270E−04 | −1.09360E−04 |
| R12 | −5.23643E+00 | −6.17190E−03 | −5.84450E−04 | 4.35250E−04 | −1.40020E−04 | 2.76620E−05 |

| | Conic coefficient | | | | | |
|---|---|---|---|---|---|---|
| | k | A14 | A16 | A18 | A20 | / |
| R1 | −2.08955E+02 | −6.56650E−12 | 1.77400E−13 | 2.32180E−14 | −8.20700E−16 | / |
| R2 | 0.00000E+00 | 0.00000E+00 | 0.00000E+00 | 0.00000E+00 | 0.00000E+00 | / |
| R3 | −5.34619E−02 | 1.50700E−06 | −2.16230E−07 | 1.69630E−08 | −5.52850E−10 | / |
| R4 | −3.43979E+00 | −6.22060E−05 | 3.94500E−06 | −6.42570E−08 | −2.63070E−09 | / |
| R5 | −3.44643E+00 | −4.03970E−06 | −5.11850E−06 | 6.87750E−07 | −2.90330E−08 | / |
| R6 | −1.24037E+02 | 1.82960E−04 | −1.79830E−05 | 1.10830E−06 | −3.16030E−08 | / |
| R7 | −1.73927E+00 | −1.56450E−04 | 4.74000E−05 | −5.29960E−06 | 2.23320E−07 | / |
| R8 | 1.13325E−01 | −7.13490E−04 | 1.64230E−04 | −1.93440E−05 | 9.37610E−07 | / |
| R9 | 2.30539E−01 | 2.14330E−04 | −4.56710E−05 | 5.32730E−06 | −2.61450E−07 | / |
| R10 | 5.56813E+00 | 1.30090E−05 | −6.27990E−07 | 3.50390E−09 | 5.32220E−10 | / |
| R11 | −7.07356E+00 | 1.22690E−05 | −8.57110E−07 | 3.42930E−08 | −6.28830E−10 | / |
| R12 | −5.23643E+00 | −3.38580E−06 | 2.40680E−07 | −8.44370E−09 | 8.94030E−11 | / |

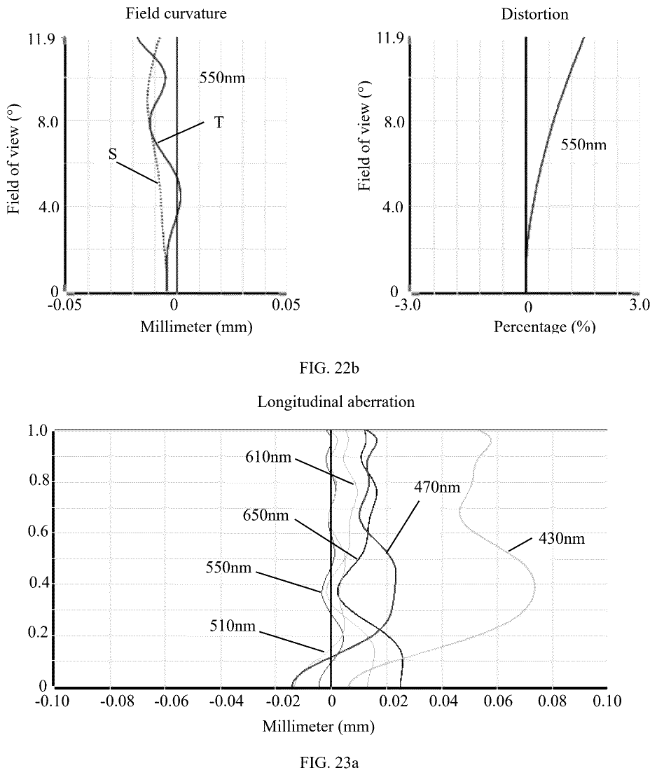

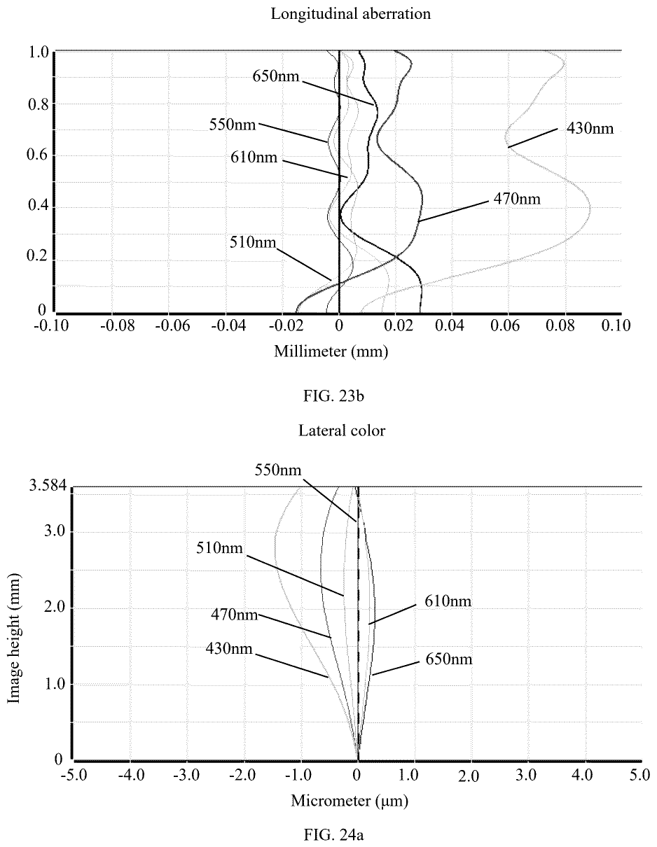

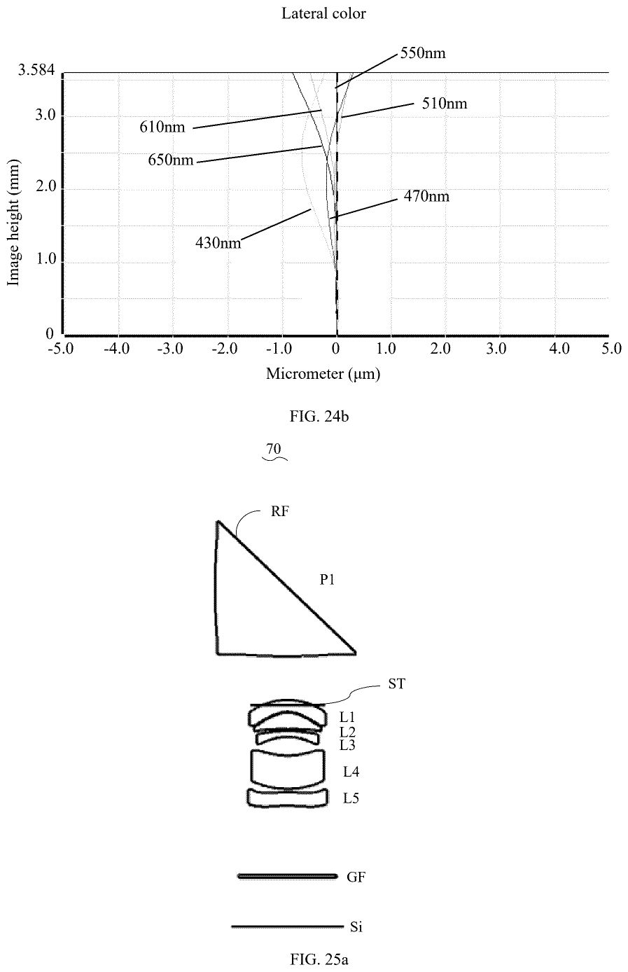

FIG. 22a and FIG. 22b are the schematic diagrams of a field curvature and a distortion after light with a wavelength of 546 nm passes through the camera optical lens 60 of the sixth embodiment. FIG. 23a and FIG. 23b are the schematic diagrams of a longitudinal aberration after light with wavelengths of 436 nm, 486 nm, 546 nm, 588 nm, and 656 nm pass through the camera optical lens 60 of the sixth embodiment. FIG. 24a and FIG. 24b are the schematic diagrams of a lateral color after light with wavelengths of 436 nm, 486 nm, 546 nm, 588 nm, and 656 nm pass through the camera optical lens 60 of the sixth embodiment.

In this embodiment, an entrance pupil diameter ENPD of the camera optical lens 60 in the first state is 5.324 mm, an image height IH is 3.584 mm, and a field of view FOV is 25.32°. The camera optical lens 60 can realize a large-aperture periscope design and has excellent optical performance, and the on-axis and off-axis chromatic aberrations are fully corrected with excellent optical characteristics.

### Seventh Embodiment

The first prism P1 has a positive refractive power, with the object side surface being convex in the paraxial region and the image side surface being convex in the paraxial region.

The first lens L1 has a negative refractive power, with the object side surface being convex in the paraxial region and the image side surface being concave in the paraxial region.

The second lens L2 has a positive refractive power, with the object side surface being convex in the paraxial region and the image side surface being concave in the paraxial region.

The third lens L3 has a negative refractive power, with the object side surface being convex in the paraxial region and the image side surface being concave in the paraxial region.

The fourth lens L4 has a negative refractive power, with the object side surface being concave in the paraxial region and the image side surface being convex in the paraxial region.

The fifth lens L5 has a positive refractive power, with the object side surface being convex in the paraxial region and the image side surface being concave in the paraxial region.

FIG. 25a and FIG. 25b are schematic structural diagrams of the camera optical lens 70 in the seventh embodiment, and the meanings of the symbols in the seventh embodiment are the same as the meanings of the symbols in the first embodiment.

Table 19 shows the design data of the camera optical lens 70 in the seventh embodiment.

TABLE 19

| | R | d | | nd | | vd | |
|---|---|---|---|---|---|---|---|
| ST | ∞ | d0 | d0 | / | / | / | / |
| Rp1 | 44.156 | dp1 | 10.000 | nd1 | 1.5168 | vd1 | 64.17 |
| Rp2 | −37.742 | dp2 | dp2 | | | | |
| R1 | 4.301 | d1 | 0.858 | nd2 | 1.5444 | vd2 | 55.82 |
| R2 | 1.735 | d2 | 0.050 | | | | |
| R3 | 1.742 | d3 | 1.189 | nd3 | 1.5444 | vd3 | 55.82 |
| R4 | 16.088 | d4 | 0.133 | | | | |
| R5 | 5.742 | d5 | 0.445 | nd4 | 1.6400 | vd4 | 23.54 |
| R6 | 3.315 | d6 | d6 | | | | |
| R7 | −4.747 | d7 | 2.406 | nd5 | 1.6610 | vd5 | 20.53 |
| R8 | −7.996 | d8 | 0.245 | | | | |
| R9 | 6.283 | d9 | 0.986 | nd6 | 1.6153 | vd6 | 25.94 |
| R10 | 8.832 | d10 | 5.000 | | | | |
| R11 | ∞ | d11 | 0.210 | ndg | 1.5168 | vdg | 64.17 |
| R12 | ∞ | d12 | 3.554 | | | | |

Where dp1 = “dp1-01” + “dp1-02”, “dp1-01” = 5.017, “dp1-02” = 4.983.

Table 20 lists the data of relevant optical parameters of the camera optical lens 70 in the first state and the second state respectively according to the seventh embodiment of the present disclosure.

TABLE 20

| | In the first state | In the second state |
|---|---|---|
| fA | 18.278 | 15.156 |
| FOV | 21.85° | 19.82° |
| FNO | 2.95 | 3.16 |
| d0 | 13.551 | 11.621 |
| dp2 | 3.159 | 1.230 |
| d6 | 1.346 | 3.275 |

Table 21 shows the conic coefficient k and aspheric coefficient of the camera optical lens 70.

TABLE 21

| | Conic | | | | | |
|---|---|---|---|---|---|---|
| | coefficient | Aspheric surface coefficient | | | | |
| | k | A4 | A6 | A8 | A10 | A12 |
| R1 | −3.14624E+01 | 5.34490E−06 | −2.73430E−07 | 3.45390E−09 | 2.50840E−09 | −2.59910E−10 |
| R2 | 0.00000E+00 | 0.00000E+00 | 0.00000E+00 | 0.00000E+00 | 0.00000E+00 | 0.00000E+00 |
| R3 | 2.67367E−02 | −1.81770E−03 | 6.13510E−04 | −1.18370E−04 | 2.78390E−05 | −6.93940E−06 |
| R4 | −3.33550E+00 | 1.93710E−03 | −1.90240E−03 | 3.76250E−03 | −1.92240E−03 | 4.73090E−04 |
| R5 | −3.26985E+00 | 2.82220E−03 | −1.69640E−03 | 3.54960E−03 | −1.56580E−03 | 2.67670E−04 |
| R6 | −2.97529E+01 | −3.01930E−02 | 3.36280E−02 | −1.78650E−02 | 5.83270E−03 | −1.25480E−03 |
| R7 | −5.78123E−01 | −3.98670E−02 | 3.71800E−02 | −1.94300E−02 | 5.11800E−03 | −3.70440E−04 |
| R8 | 1.13742E−01 | −1.65160E−02 | 1.07290E−02 | −4.64200E−03 | −5.44370E−04 | 1.51890E−03 |
| R9 | 6.51738E−01 | 6.41500E−03 | −9.89210E−05 | −8.00440E−04 | 9.66930E−04 | −5.94630E−04 |
| R10 | 4.41785E+00 | −1.82270E−02 | 9.09150E−03 | −3.18640E−03 | 7.91480E−04 | −1.30830E−04 |
| R11 | −1.59615E+01 | −2.70370E−02 | 7.80240E−03 | −2.61560E−03 | 6.34800E−04 | −1.08580E−04 |
| R12 | −3.13678E+01 | −8.26330E−03 | −5.27580E−04 | 4.31760E−04 | −1.40420E−04 | 2.77590E−05 |

| | Conic coefficient | | | | | |
|---|---|---|---|---|---|---|
| | k | A14 | A16 | A18 | A20 | / |
| R1 | −3.14624E+01 | 3.25790E−12 | 6.49920E−13 | −3.23700E−14 | 4.58990E−16 | / |
| R2 | 0.00000E+00 | 0.00000E+00 | 0.00000E+00 | 0.00000E+00 | 0.00000E+00 | / |
| R3 | 2.67367E−02 | 1.49890E−06 | −2.14190E−07 | 1.69630E−08 | −5.52850E−10 | / |
| R4 | −3.33550E+00 | −6.22760E−05 | 3.94500E−06 | −6.42570E−08 | −2.63070E−09 | / |
| R5 | −3.26985E+00 | −4.03970E−06 | −5.11850E−06 | 6.87750E−07 | −2.90330E−08 | / |
| R6 | −2.97529E+01 | 1.82960E−04 | −1.79830E−05 | 1.10830E−06 | −3.16030E−08 | / |
| R7 | −5.78123E−01 | −1.56450E−04 | 4.74000E−05 | −5.29960E−06 | 2.23320E−07 | / |
| R8 | 1.13742E−01 | −7.13490E−04 | 1.64230E−04 | −1.93440E−05 | 9.37610E−07 | / |
| R9 | 6.51738E−01 | 2.14330E−04 | −4.56710E−05 | 5.32730E−06 | −2.61450E−07 | / |
| R10 | 4.41785E+00 | 1.30090E−05 | −6.27990E−07 | 3.50390E−09 | 5.32220E−10 | / |
| R11 | −1.59615E+01 | 1.22690E−05 | −8.57110E−07 | 3.42930E−08 | −6.28830E−10 | / |
| R12 | −3.13678E+01 | −3.38820E−06 | 2.40680E−07 | −8.44370E−09 | 8.94030E−11 | / |

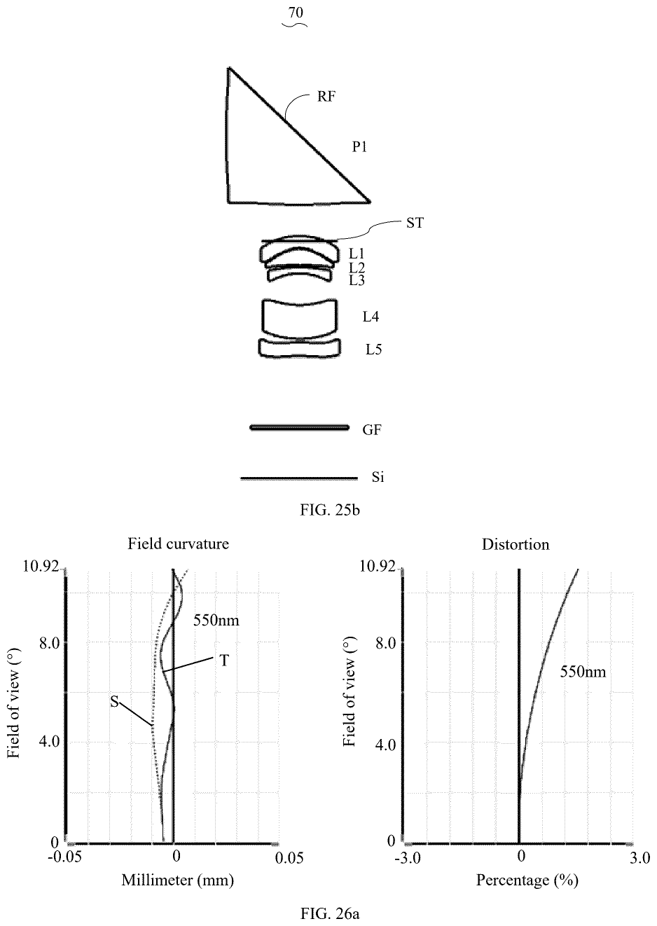

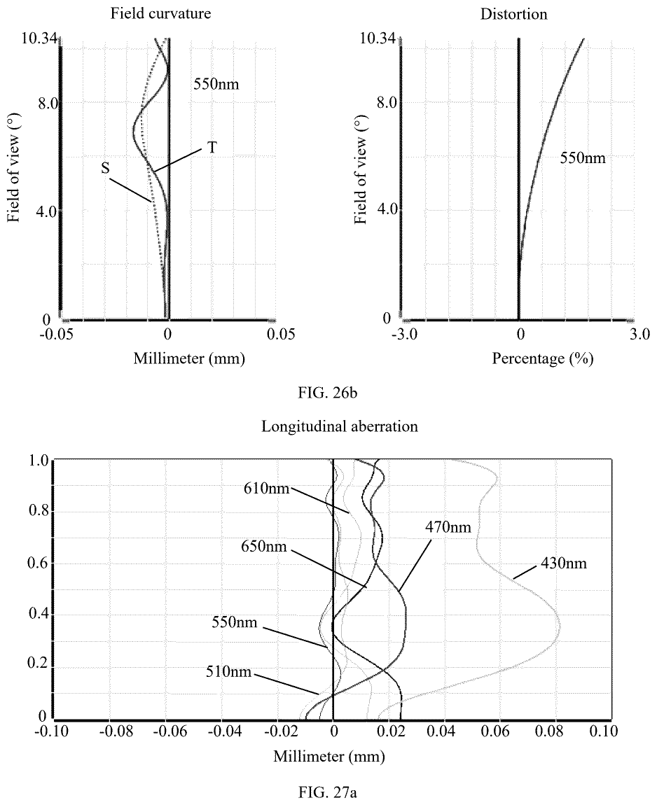

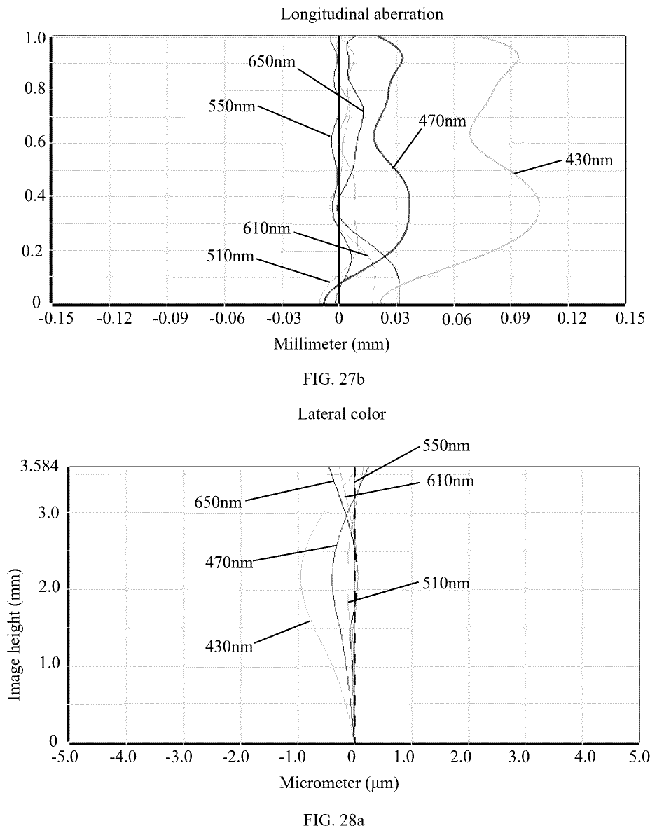

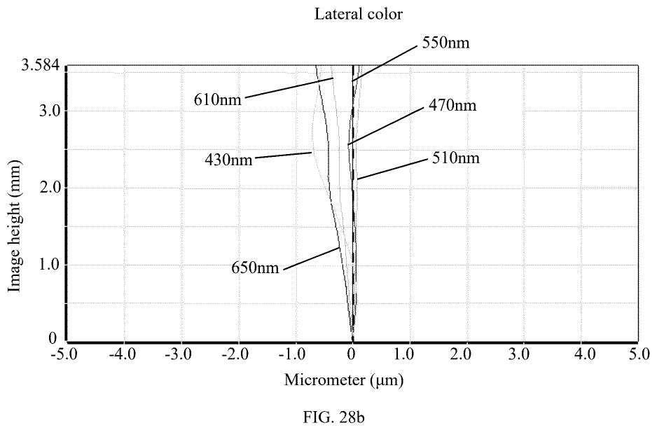

FIG. 26a and FIG. 26b are the schematic diagrams of a field curvature and a distortion after light with a wavelength of 546 nm passes through the camera optical lens 70 of the seventh embodiment. FIG. 27a and FIG. 27b are the schematic diagrams of a longitudinal aberration after light with wavelengths of 436 nm, 486 nm, 546 nm, 588 nm, and 656 nm pass through the camera optical lens 70 of the seventh embodiment. FIG. 28a and FIG. 28b are the schematic diagrams of a lateral color after light with wavelengths of 436 nm, 486 nm, 546 nm, 588 nm, and 656 nm pass through the camera optical lens 70 of the seventh embodiment.

In this embodiment, an entrance pupil diameter ENPD of the camera optical lens 70 in the first state is 6.195 mm, an image height IH is 3.584 mm, and a field of view FOV is 21.85°. The camera optical lens 70 can realize a large-aperture periscope design and has excellent optical performance, and the on-axis and off-axis chromatic aberrations are fully corrected with excellent optical characteristics.

Table 22 below shows the values corresponding to the parameters specified in the conditions for various numerical values in the first, second, third, fourth, fifth, sixth and seventh embodiments.

TABLE 22

| Parameters and | | | |
|---|---|---|---|
| conditional | First | Second | Third |
| equations | embodiment | embodiment | embodiment |
| fA/IH | 4.05 | 5.33 | 4.80 |
| Rp1/Rp2 | 0.20 | 0.00 | 0.68 |
| f1/fA | −1.62 | −1.42 | −1.96 |
| BF/TTL | 0.21 | 0.32 | 0.20 |
| (R1 + R2)/(R1 − R2) | 3.08 | 4.55 | 4.02 |
| fA | 14.515 | 19.110 | 17.218 |
| fp1 | 34.296 | 27.112 | 48.082 |
| f1 | −23.515 | −27.137 | −33.785 |
| f2 | 8.355 | 9.748 | 8.556 |
| f3 | −161.058 | 613.940 | −86.022 |
| f4 | 161.443 | 173.918 | −3544.143 |
| f5 | −11.879 | −11.891 | −12.665 |
| TTL | 21.164 | 24.435 | 24.270 |
| Parameters and | | | |
| conditional | Fourth | Fifth | Sixth |
| equations | embodiment | embodiment | embodiment |
| fA/IH | 4.63 | 4.05 | 4.39 |
| Rp1/Rp2 | 0.72 | 1.02 | −0.90 |
| f1/fA | −1.46 | −1.10 | −0.66 |
| BF/TTL | 0.11 | 0.18 | 0.28 |
| (R1 + R2)/(R1 − R2) | 3.07 | 2.42 | 3.33 |
| fA | 16.587 | 14.515 | 15.724 |
| fp1 | 53.248 | 162.165 | 102.889 |
| f1 | −24.217 | −15.967 | −10.348 |
| f2 | 7.968 | 6.685 | 4.321 |
| f3 | −80.954 | 1879.236 | −11.972 |
| f4 | 746.772 | −37.747 | −15.872 |
| f5 | −11.679 | −28.504 | 15.640 |
| TTL | 26.316 | 23.242 | 25.693 |
| Parameters and | | | |
| conditional | Seventh | | |
| equations | embodiment | / | / |
| fA/IH | 5.10 | / | / |
| Rp1/Rp2 | −1.17 | / | / |
| f1/fA | −0.33 | / | / |
| BF/TTL | 0.30 | / | / |
| (R1 + R2)/(R1 − R2) | 2.35 | / | / |
| fA | 18.278 | / | / |
| fp1 | 40.952 | / | / |
| f1 | −6.032 | / | / |
| f2 | 3.474 | / | / |
| f3 | −13.087 | / | / |
| f4 | −24.872 | / | / |
| f5 | 30.568 | / | / |
| TTL | 29.581 | / | / |

The camera optical lens provided by the embodiments of the present disclosure has been described in detail. Herein, the principle and embodiments of the present disclosure are described by using specific examples. The description of the above embodiments is only intended to help understand the idea of the present disclosure, and there will be changes in the specific embodiments and application scope. To sum up, the contents of the specification should not be understood as limiting the present disclosure.

What is claimed is:

1. A camera optical lens comprising, from an object side to an image side in sequence: a first prism with a positive refractive power, a first lens with a negative refractive power, a second lens with a positive refractive power, a third lens, a fourth lens, and a fifth lens;
wherein a reflecting surface is provided between an object side surface and an image side surface of the first prism, the first lens, the second lens and the third lens form a first lens group, the fourth lens and the fifth lens form a second lens group, and the first lens group is arranged to be movable and adjustable along an optical axis of the camera optical lens, to switch the camera optical lens between a first state and a second state, wherein the camera optical lens has a maximum focal length in the first state, and the camera optical lens has a minimum focal length in the second state;
wherein the camera optical lens further satisfies the following conditions:
$$4. \leq fA / IH \leq 5 \text{.50} ; \\ - 1.2 \leq Rp 1 / Rp 2 \leq 1 \text{.10} ; \\ - 2. \leq f 1 / fA \leq - 0 \text{.30} ; \\ 0.11 \leq BF / TTL \leq 0 \text{.33} ;$$
where
fA: the focal length of the camera optical lens in the first state;
IH: an image height of the camera optical lens;
Rp1: a curvature radius of the object side surface of the first prism;
Rp2: a curvature radius of the image side surface of the first prism;
f1: a focal length of the first lens;
BF: a back focal length of the camera optical lens; and
TTL: a total optical length of the camera optical lens.

2. The camera optical lens according to claim 1, further satisfying the following condition:
$$4. \leq fA / IH \leq 5.34 .$$

3. The camera optical lens according to claim 1, further satisfying the following condition:
$$2.3 \leq ( R 1 + R 2 ) / ( R 1 - R 2 ) \leq 4 \text{.60} ;$$
where
R1: a curvature radius of an object side surface of the first lens; and
R2: a curvature radius of an image side surface of the first lens.

4. The camera optical lens according to claim 1, wherein the object side surface of the first prism is curved and convex in a paraxial region, and the camera optical lens further satisfies the following conditions:
$$1. 41 \leq fp 1 / fA \leq 11 \text{.18} ; \\ 0.26 \leq dp 1 / TTL \leq 0 \text{.34} ;$$
where
fp1: a focal length of the first prism; and
dp1: a sum of an on-axis distance from the object side surface of the first prism to the reflecting surface and an on-axis distance from the reflecting surface to the image side surface of the first prism.

5. The camera optical lens according to claim 1, wherein an object side surface of the first lens is convex in a paraxial region, an image side surface of the first lens is concave in the paraxial region, and the camera optical lens further satisfies the following condition:
$$0.018 \leq d 1 / TTL \leq 0.0 \; 37 ;$$
where
d1: an on-axial thickness of the first lens.

6. The camera optical lens according to claim 1, wherein an object side surface of the second lens is convex in a paraxial region, and the camera optical lens further satisfies the following conditions:
$$- 1.25 \leq ( R 3 + R 4 ) / ( R 3 - R 4 ) \leq 0.24 ; \\ 0.19 \leq f 2 / fA \leq 0 \text{.58} ; \\ 0.04 \leq d 3 / TTL \leq 0 \text{.08} ;$$
where
R3: a curvature radius of the object side surface of the second lens;
R4: a curvature radius of an image side surface of the second lens;
f2: a focal length of the second lens; and
d3: an on-axis thickness of the second lens.

7. The camera optical lens according to claim 1, further satisfying the following conditions:
$$- 111.10 \leq ( R 5 + R 6 ) / ( R 5 - R 6 ) \leq 14 \; 9 \text{.30} ; \\ - 11. 10 \leq f 3 / fA \leq 12 \; 9 \text{.47} ; \\ 0.015 \leq d 5 / TTL \leq 0.1 \; 06 ;$$
where
R5: a curvature radius of an object side surface of the third lens;
R6: a curvature radius of an image side surface of the third lens;
f3: a focal length of the third lens; and
d5: an on-axis thickness of the third lens.

8. The camera optical lens according to claim 1, further satisfying the following conditions:
$$- 3.93 \leq ( R 7 + R 8 ) / ( R 7 - R 8 ) \leq 610 \; 4 \text{.00} ; \\ - 205.84 \leq f 4 / fA \leq 45.03 ; \\ 0.06 \leq d 7 / TTL \leq 0 \text{.12} ;$$
where
R7: a curvature radius of an object side surface of the fourth lens;
R8: a curvature radius of an image side surface of the fourth lens;
f4: a focal length of the fourth lens; and
d7: an on-axis thickness of the fourth lens.

9. The camera optical lens according to claim 1, wherein an image side surface of the fifth lens is concave in a paraxial region, and the camera optical lens further satisfies the following conditions:
$$- 5.93 \leq ( R 9 + R 10 ) / ( R 9 - R 10 ) \leq 6 \text{.18} ; \\ - 1.97 \leq f 5 / fA \leq 1.68 ; \\ 0.02 \leq d 9 / TTL \leq 0 \text{.11} ;$$
where
R9: a curvature radius of an object side surface of the fifth lens;
R10: a curvature radius of the image side surface of the fifth lens;
f5: a focal length of the fifth lens; and
d9: an on-axis thickness of the fifth lens.

10. The camera optical lens according to claim 1, wherein the first prism is made of glass.
